(19) United States
(12) Patent Application Publication
(10) Pub. No.: US 2013/0280391 A1
(43) Pub. Date: Oct. 24, 2013

(54) ANTI-MICROBIAL WASH COMPOSITIONS INCLUDING CERAGENIN COMPOUNDS AND METHODS OF USE FOR TREATING NON-MEAT FOOD PRODUCTS

(71) Applicant: BRIGHAM YOUNG UNIVERSITY, Provo, UT (US)

(72) Inventor: Paul B. Savage, Mapleton, UT (US)

(73) Assignee: BRIGHAM YOUNG UNIVERSITY, Provo, UT (US)

(21) Appl. No.: 13/841,549

(22) Filed: Mar. 15, 2013

Related U.S. Application Data
(60) Provisional application No. 61/637,402, filed on Apr. 24, 2012.

(51) Int. Cl. A23L 3/3526

(52) U.S. Cl. CPC A23L 3/3526
USPC 426/310; 426/532; 514/169; 514/182; 514/64; 514/176; 514/63

(57) ABSTRACT

Disclosed herein are anti-microbial wash compositions and methods for using such compositions in controlling microbe growth on a non-meat food product (e.g., fruits, vegetables, grains, eggs, etc.) by applying or contacting the anti-microbial wash composition with a surface of the food product to kill microbes (e.g., bacteria) on a surface of the food product. The anti-microbial wash compositions include a ceragenin compound dispersed in a fluid carrier. The ceragenin compound includes a sterol backbone and a number of cationic groups attached to the sterol backbone. The cationic groups may be attached to the sterol backbone by a hydrolysable linkage so that the ceragenin compound has a relatively short half life (e.g., less than about 40 days), and the wash composition may be applied prior to shipping and washed off after shipping to minimize any ceragenin compound residue.

### CROSS-REFERENCE TO RELATED APPLICATIONS

This application claims the benefit of U.S. Provisional Patent Application Ser. No. 61/637,402, titled “Anti-Microbial Wash Compositions Incorporating Ceragenin Compounds And Method Of Use For Treating Non-Meat Food Products,” filed Apr. 24, 2012, which is hereby incorporated herein by reference.

### BACKGROUND

Eliminating and/or minimizing growth of bacteria, viruses and other harmful microbes in the processing of food products, including non-meat products (e.g., fruits, vegetables, grains, etc.), is a major concern. In a processing center where fruits, vegetables, grains, or other plant sourced food products are processed and packaged bacterial infestation of such food products can lead to serious illness, and even death as contaminated food products are distributed to consumers. Thus, it is very important to the food safety of such products that bacteria and other microbes be adequately controlled during processing, packaging, and shipping of such food products.

Campylobacter bacteria and Salmonella bacteria represent two of the main causes of food borne illness in the United States, contributing to an estimated 9.4 million food-related illnesses, nearly 56,000 hospitalizations, and over 1,300 deaths each year in the United States alone. The cost of this problem is about $48 billion each year. Although Campylobacter and Salmonella contamination is more common in meat, dairy, and egg food products, these bacteria are also known to contaminate fruits, vegetables, and other plant sourced food products.

One particular difficulty in adequately controlling the growth of such bacteria lies in the fact that although Campylobacter and Salmonella may contribute to a large share of the problem, a wide variety of bacteria can be encountered in such food processing, making it difficult to always anticipate which particular bacterial strains are likely to be problematic. Furthermore, there are numerous specific strains within each of the Campylobacter and Salmonella classes. In addition, available antibiotics are typically selective in their efficacy. In other words, although a given antibiotic may be effective against a particular bacterial strain, it may have little or no efficacy against another bacterial strain. In addition, some bacterial strains are known to develop resistance to antibiotics, such that it has been difficult up to the present time to adequately control bacterial growth through the use of antibiotics in the field of food processing.

In order to minimize or prevent growth of the wide variety of bacterial strains that may be encountered, such food products may be subjected to various treatments, such as washing in chlorinated water, treatment with non-thermal irradiation (i.e., cold pasteurization) in order to maintain the safety of the food product. Chlorinated aqueous washes are generally viewed as acting to physically remove a significant fraction of any pathogenic bacteria, rather than actually oxidizing and killing such bacteria. In other words, the level of chlorine and the contact time allowable under current regulation is insufficient to actually kill a significant fraction of pathogens that remain on the food product. Higher concentrations and/or longer contact times negatively affect the quality characteristics (e.g., color, texture, smell, etc.) of the food product, and are unacceptable. The chlorine within the water serves to prevent or minimize build up of pathogens within the wash water itself, as it is able to oxidize those bacteria or bacterial spores that are washed therein. While chlorinated water can be effective in preventing build up of pathogens in the wash water itself, it is important to control the pH of the wash composition, and to limit the presence of any organic matter that may find its way into the wash water, as such factors render the chlorine ineffective. When the pH changes and/or organic matter levels become too high, the wash water itself can actually become a source of contamination.

Thus, there continues to be a need for improved sanitation techniques that may be employed with such food products, particularly where such techniques might provide improved efficacy, lower complexity (e.g., required in monitoring and maintaining variables within required ranges), and at lower cost.

### BRIEF SUMMARY

Disclosed herein are anti-microbial wash compositions and methods for using these compositions in controlling microbe growth on a non-meat food product by applying or contacting the anti-microbial wash composition to a surface of the non-meat food product to kill microbes (e.g., bacteria) on a surface of the food product. The terms “applied” and “contacted” and their derivatives are used interchangeably herein. The anti-microbial wash compositions include a ceragenin compound dispersed (e.g., suspended or dissolved) in a fluid carrier. The ceragenin compound includes a sterol backbone and a number (e.g., at least two or at least three) of cationic groups attached to the sterol backbone.

Suitable examples of carriers include, but are not limited to, water, alcohols, oils, organic solvents, organic/aqueous emulsions, and combinations thereof. Wash compositions including such liquid carriers may be sprayed onto a desired food product, or may provide a bath into which the food product is dipped (e.g., immersed). It may also be possible for the carrier to comprise a gaseous carrier, within which the ceragenin compound(s) are dispersed (e.g., suspended), which gaseous “wash composition” may be blanketed around or otherwise applied or contacted with the surface of a food product. In any case, the ceragenin compounds may remain on the surface of the food product short term so as to provide continuing anti-microbial effect even after active application of the wash composition is completed (e.g., after the food product is withdrawn from a dip tank containing the wash composition or the wash composition is no longer being actively sprayed onto the food product).

In preferred embodiments, the ceragenin compound does not persist long term on the food product so as to minimize ingestion by the end consumer. For example, the ceragenin compound may degrade relatively quickly (e.g., a matter of days or weeks) due to environmental conditions. For example, in one embodiment, the ceragenin compound has a half-life of less than about 40 days. A hydrolysable ceragenin in a water carrier may advantageously provide such characteristics. Furthermore, even if some residual ceragenin compound were to remain on the non-meat food product, the ceragenin compound may be adapted so as to be destroyed, even without the food product being cooked. Where such food products are cooked, the ceragenin compound may be destroyed during cooking. Where the food product is eaten raw (e.g., raw fruits or vegetables), the ceragenin compounds may be adapted to be destroyed by lipase enzymes typically present within the stomach. Thus, the ceragenin compounds may include multiple characteristics configured to minimize ingestion or any negative effects of such ingestion.

Finally, even if such ceragenin compounds were to somehow survive environmental destructive action and the destructive action of lipase, it has advantageously and surprisingly been found that the concentrations of such ceragenin compounds required to kill illness causing bacteria that may be present on the surface of such non-meat food products is well below the concentration required to kill beneficial bacteria that normally reside within the digestive system of those who would consume the treated food product. As such, even if some residual ceragenin compounds were to survive the above safeguards and enter a person's digestive system, their presence would cause no significant negative consequences.

One simple mechanism to limit risk of ingestion of the ceragenin compound is to apply a wash composition including a degradable ceragenin compound prior to shipping of the food product, and then to rinse the food product prior to delivery or sale to the end consumer. For example, for many produce food products (e.g., tomatoes and other fresh fruits and vegetables), there may be a time period of several weeks between harvest and delivery to the end consumer. A wash composition including a hydrolysable ceragenin in a water carrier might exhibit a half-life of less than about 40 days, so that the majority of the ceragenin applied soon after harvest may provide antimicrobial protection during shipping, but may have largely degraded by the time of delivery to the end consumer. In one embodiment, the food product may be rinsed prior to such delivery to further remove any residual ceragenin compound from the food product.

As described above, the ceragenin compounds may be selected so that the cationic groups are attached to the sterol backbone via a degradable linkage that will cause the ceragenin compound to degrade as a result of environmental action (e.g., as a result of exposure to pH values greater than about 6). In a specific embodiment, the cationic groups may be attached to the sterol backbone via a hydrolysable linkage so that the compound will degrade over time, e.g., after use. Such embodiments may be preferred where it is desirable that the compound be readily degradable within the environment, so as to minimize the possibility of ingestion by an end user, and/or build up of such compounds within the body of an end user. Furthermore, advantageously, the ceragenin compound can be configured so that its degradation products are materials that are naturally found within nature, and the body.

According to an exemplary method of use an anti-microbial wash composition is provided that includes a fluid carrier and a ceragenin compound dispersed within the carrier. The carrier includes a sterol backbone and a number of cationic groups attached thereto. The ceragenin compound is included within the wash composition in a concentration range so as to be effective. The anti-microbial wash composition is contacted with a surface of a food product for a suitable period of time to kill one or more types of microbes on the surface of the food product. Furthermore, the concentration selected may be sufficiently high to kill illness causing bacteria such as Campylobacter and Salmonella, while at the same time being too low to kill beneficial bacteria that reside within the digestive system of a typical end consumer. This protects the end consumer from being subjected to something akin to an antibiotic flush in the event that residual ceragenin compound is ingested. As described above, because the ceragenin compounds are destroyed simply through environmental action and the action of stomach lipase, it is unlikely that any such residual ceragenin compound would ever reach the intestinal tract of the end user.

It is contemplated that the anti-microbial wash compositions may be applied to vegetables, fruits, grains, and other non-meat or plant sourced food products. Typically, the food products to be treated might be solid articles, e.g., pieces of fruit, grains, or vegetables that can be dipped or sprayed with the wash composition, which composition may then be allowed to drain away from the treated article.

Other non-meat food products, such as dairy products (e.g., milk, yogurt, cheeses before pressing into solid form, etc.) that might not typically be considered as solid articles might also be treated through application of the inventive anti-microbial wash compositions, even where the composition may not be able to drain away from the treated article. For example, milk, yogurt, or food products of a similar non-solid consistency (e.g., peanut butter, syrup, etc.) might also be treated in a similar manner in which chlorinated or similar wash compositions are currently employed in the processing of such food products (e.g., washing of food contact surfaces, etc.).

The anti-microbial wash compositions provide surprising and advantageous results over state of the art anti-microbial wash compositions, such as the use of chlorinated water. Chlorinated water has been shown to not actually result in killing of microbes on the food product surface, but rather the carrier (i.e., water) merely washes such microbes off of the food product surface, and into the wash composition. The chlorination of the wash water merely serves to prevent build up of pathogens within the wash composition (e.g., contact time of chlorine with pathogens washed into the wash composition may be sufficient to kill) Even short term contact of the food product with a chlorinated wash composition can result in changes to the color, texture, taste, smell, and other quality characteristics of the food product because chlorine is a non-selective oxidizing agent. This undesirably alters the quality characteristics of the food product, and exhibits only limited success in controlling microbe counts on the actual food product, as described above.

In addition, even if some chlorine was able to remain on the food product surface so as to destroy bacteria present at the time of application, because such chlorine compounds are non-selective, they simply react immediately with the food product. As a result, they alter the quality characteristics of the food product, and are not available in a potent form after wash treatment for any significant period of time after application. In other words, they are typically consumed within seconds, so that they have little or no efficacy in preventing bacterial contamination from occurring after application of a chlorine wash composition (e.g., fighting off a contamination event).

The ceragenin compounds have been found to advantageously be selective relative to bacteria and other microbes (e.g., viruses and/or fungi) while not attacking the food product itself. Furthermore, they have also been found to be selective relative to illness causing bacteria rather than beneficial bacteria present within the digestive tract of end users. In other words, a concentration required to kill beneficial bacteria is significantly higher than that required to kill illness causing bacteria (e.g., by a factor of about 50 times). That said, the ceragenin compounds are not particularly selective relative to different strains of illness causing bacteria (i.e., they kill essentially all of them) at a relatively low dose. This characteristic is particularly beneficial as compared to traditional antibiotics which must be carefully paired to ensure that a given antibiotic will kill a given bacteria. Furthermore, antibiotics are also typically known to not be selective between beneficial and illness causing bacteria.

In addition, the ceragenin compounds do not oxidize or otherwise alter the quality characteristics of the food product, which characteristic is particularly beneficial as compared to the use of existing wash compositions. As a result, the ceragenin compounds are able to selectively kill a wide variety of illness causing bacteria (with little or no risk to beneficial bacteria in the digestive tract if residual ceragenin compound is ingested) on the surface of a food product without at the same time damaging or altering quality characteristics such as color, texture, taste, and smell.

In addition, because the ceragenin compounds can be formulated to be more stable than chlorine compounds, the ceragenin compound is able to be maintained short-term in a potent state on the surface of food product, even after removal of the food product from a dip tank containing the wash composition or even after the wash composition is no longer being actively sprayed on the food product. For example, even where the carrier may dry or evaporate away, the ceragenin compounds may remain in place short term (e.g., up to several weeks) on the surface of the food product. These residual ceragenin compounds are thus able to destroy bacteria in the case that the food product becomes contaminated by bacteria after application of the wash composition (e.g., through a contamination event). As a result, the shelf-life of such food products may be significantly longer than that exhibited by the same products treated only with a state of the art wash composition, which is not able to provide significant prospective anti-microbial protection. This advantage can be provided while at the same time providing for natural degradation of the ceragenin compound after a period of several weeks (e.g., the ceragenin compound may have a half-life of less than about 40 days).

This provides the treated food product with prospective and continuing antimicrobial protection, while at the same time providing for a mechanism by which the antimicrobial ceragenin compound is automatically degraded, so as to limit its ingestion by an end consumer. The food product may further be rinsed prior to delivery (e.g., several weeks after harvest and initial application of the ceragenin containing wash composition) to an end consumer to further limit any risk of ingestion of the ceragenin. Finally, as described above, even if the ceragenin compound is ingested, there is little if any risk of adverse effects, as the ceragenin is destroyed by stomach lipase, and it insufficient in concentration to kill beneficial bacteria within the digestive tract.

Finally, as little as a single application of the present ceragenin containing wash compositions is sufficient to provide equivalent or better levels of food safety as that provided by use of state of the art wash compositions. These advantages thus allow one to effectively control microbe growth on a food product while eliminating the disadvantages incumbent with state of the art wash compositions and methods.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates exemplary hydrolysable cationic steroidal anti-microbial (“CSA”) compounds.

FIG. 1B illustrates exemplary non-hydrolysable CSA compounds.

FIG. 2 is a graph illustrating the stability of CSA-44 as a function of pH.

FIG. 3 is a graph illustrating spoilage microorganism levels on a food product over time for different CSA concentrations.

FIG. 4 is a graph illustrating reduction of Salmonella bacteria on the surface of a food product for different CSA concentrations.

FIG. 5 is a graph illustrating reduction of Campylobacter bacteria on a food surface for different CSA concentrations.

### DETAILED DESCRIPTION

### I. Brief Introduction to Ceragenins

Ceragenin compounds, also referred to herein as cationic steroidal anti-microbial compounds (“CSAs”), are synthetically produced small molecule chemical compounds that include a sterol backbone having various charged groups (e.g., amine and cationic groups) attached to the backbone. The backbone can be used to orient the amine or guanidine groups on one face, or plane, of the sterol backbone. For example, a scheme showing a compound having primary amino groups on one face, or plane, of a backbone is shown below in Scheme I:

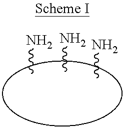

Ceragenins are cationic and amphiphilic, based upon the functional groups attached to the backbone. They are facially amphiphilic with a hydrophobic face and a polycationic face. Without wishing to be bound to any particular theory, the anti-microbial ceragenin compounds described herein act as anti-microbial agents (e.g., anti-bacterials, anti-fungals, and anti-virals). It is believed, for example, that the anti-microbial ceragenin compounds described herein act as anti-bacterials by binding to the cellular membrane of bacteria and other microbes and inserting into the cell membrane, forming a pore that allows the leakage of ions and cytoplasmic materials that are critical to the microbe's survival and leading to the death of the affected microbe. In addition, the anti-microbial ceragenin compound described herein may also act to sensitize bacteria to antibiotics. For example, at concentrations of the anti-microbial ceragenin compounds below the corresponding minimum bacteriostatic concentration, the ceragenins cause bacteria to become more susceptible to other antibiotics by increasing the permeability of the membrane of the bacteria.

The charged groups are responsible for disrupting the bacterial cellular membrane, and without the charged groups, the ceragenin compound cannot disrupt the membrane to cause cell death or sensitization. An example of a ceragenin compound is shown below as Formula I. As will be discussed in greater detail below, the R groups of Formula I can have a variety of different functionalities, thus providing a given ceragenin compound with specific, different properties. In addition, as will be appreciated by those of skill in the art, the sterol backbone can be formed of 5-member and/or 6-member rings, so that p, q, m, and n may independently be 1 (providing a 6-member ring) or 0 (providing a 5-member ring).

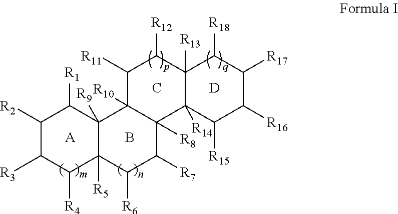

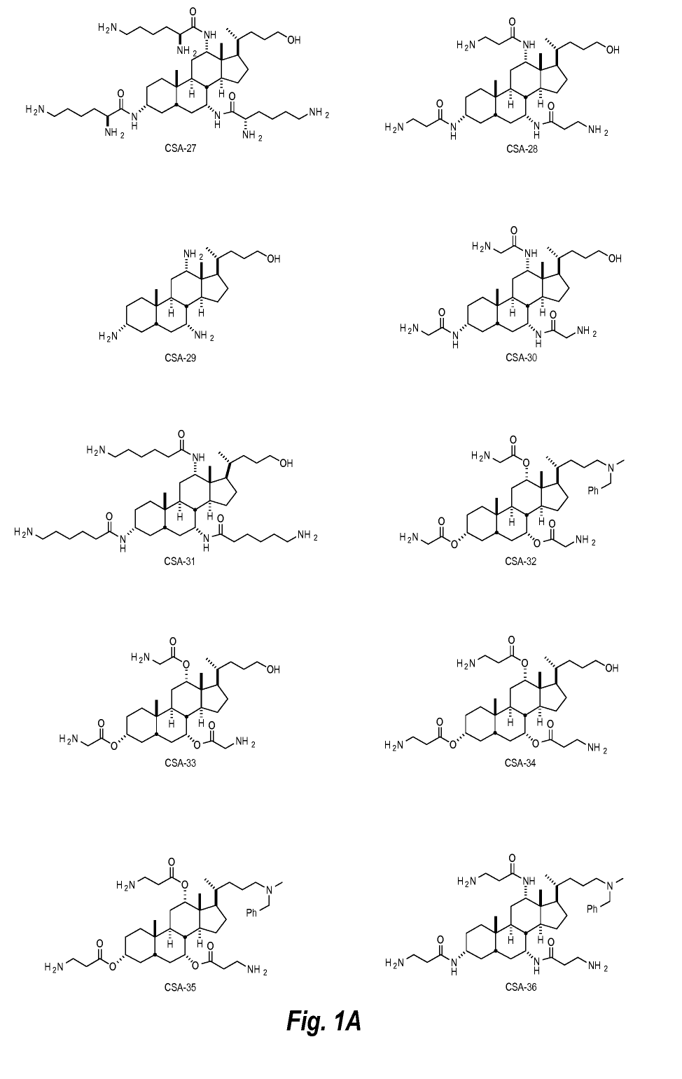

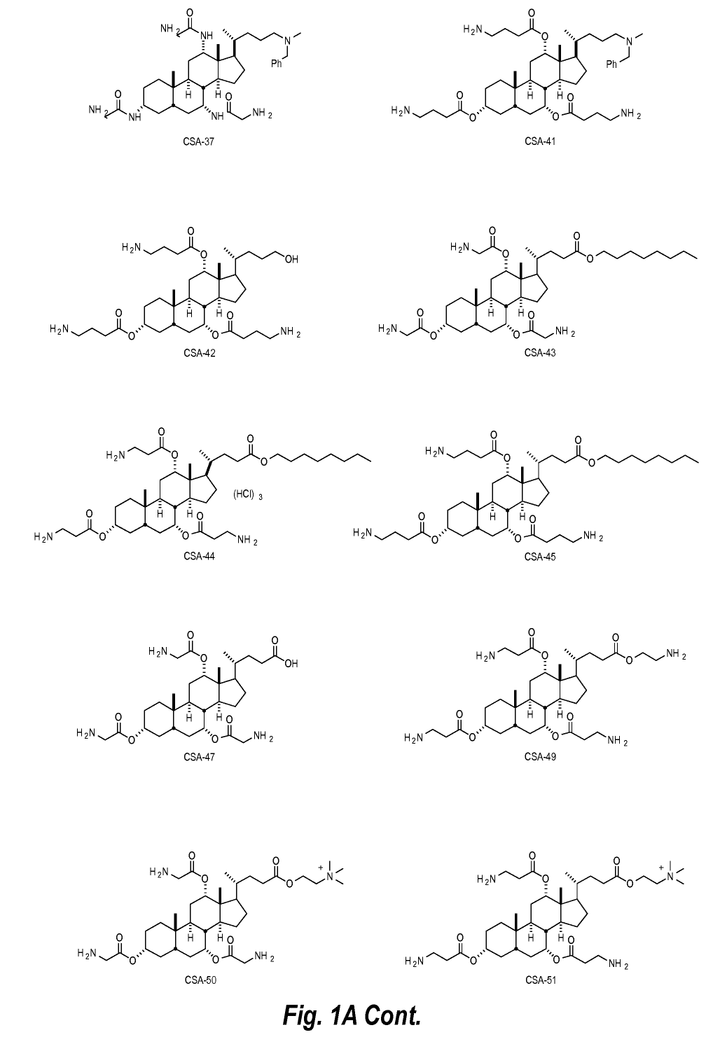

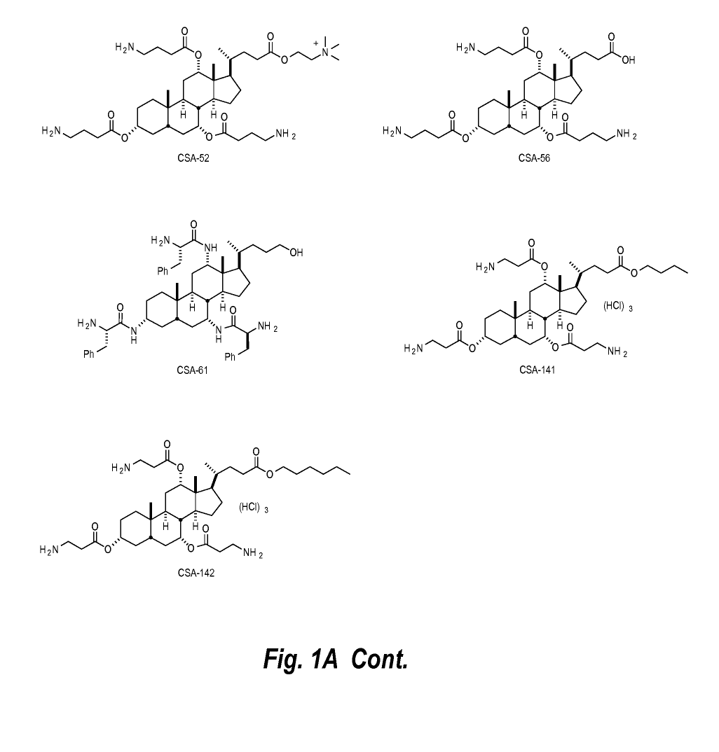

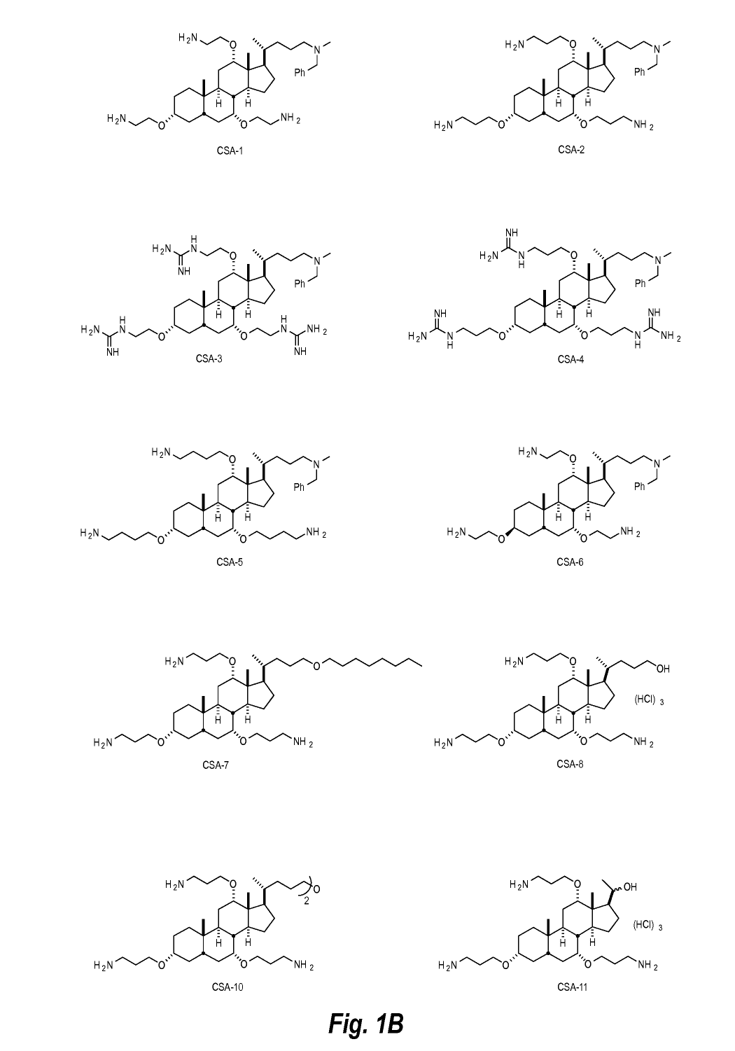

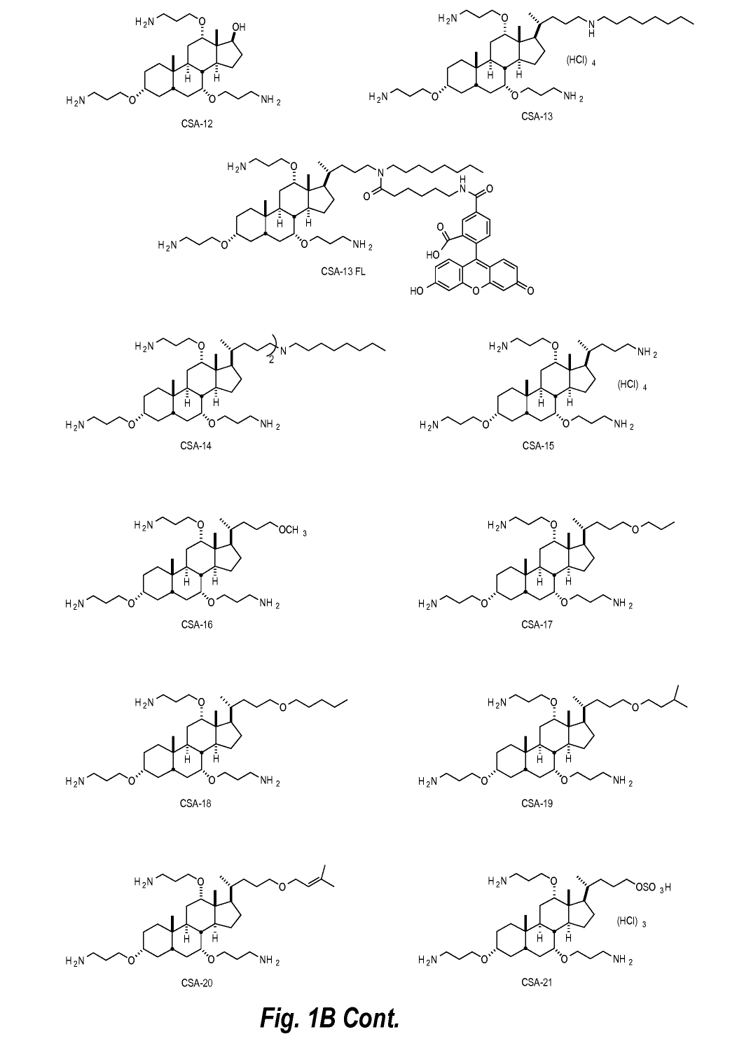

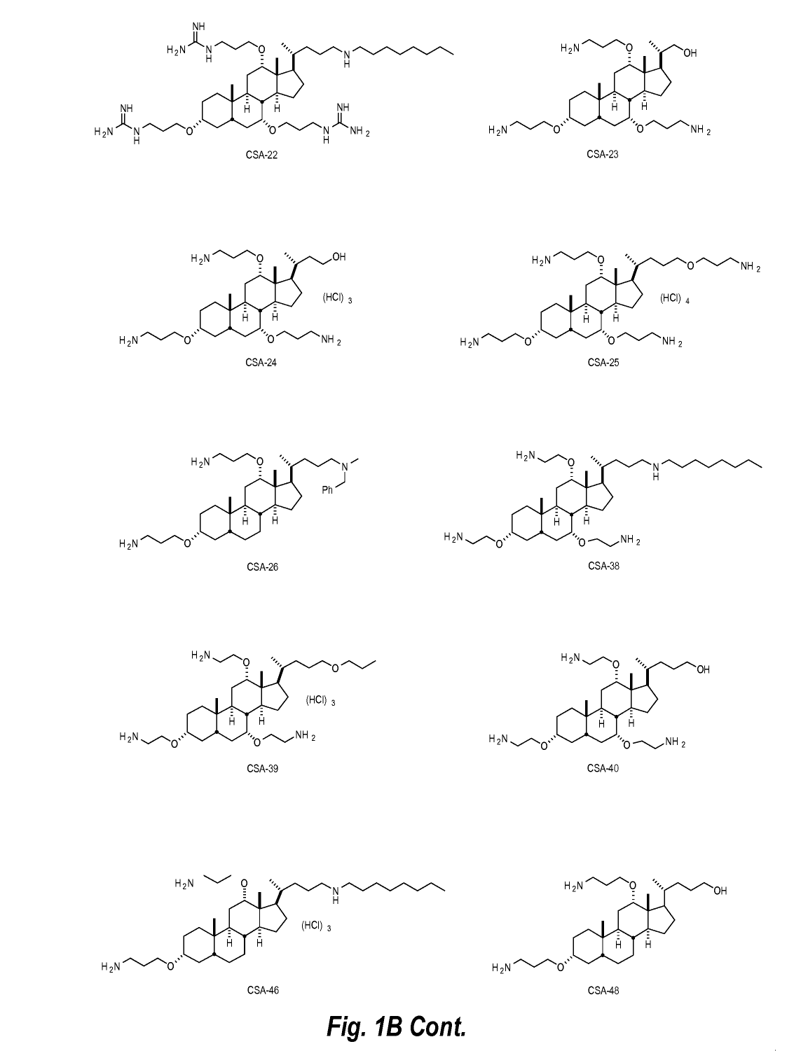

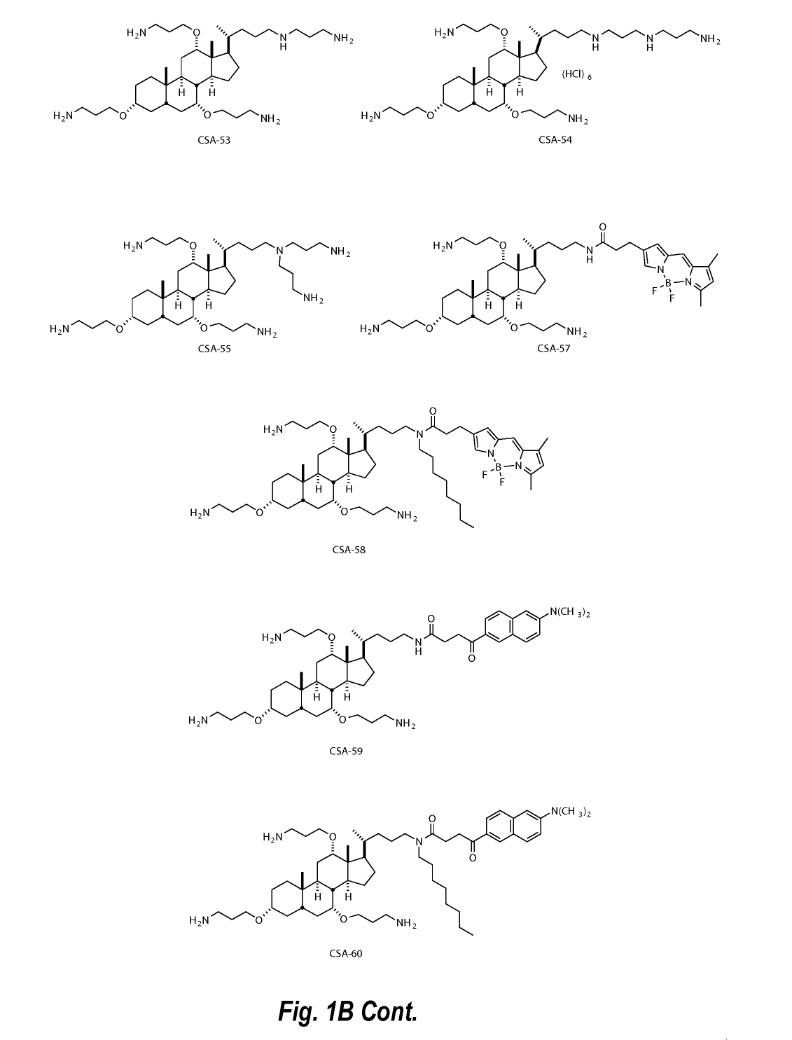

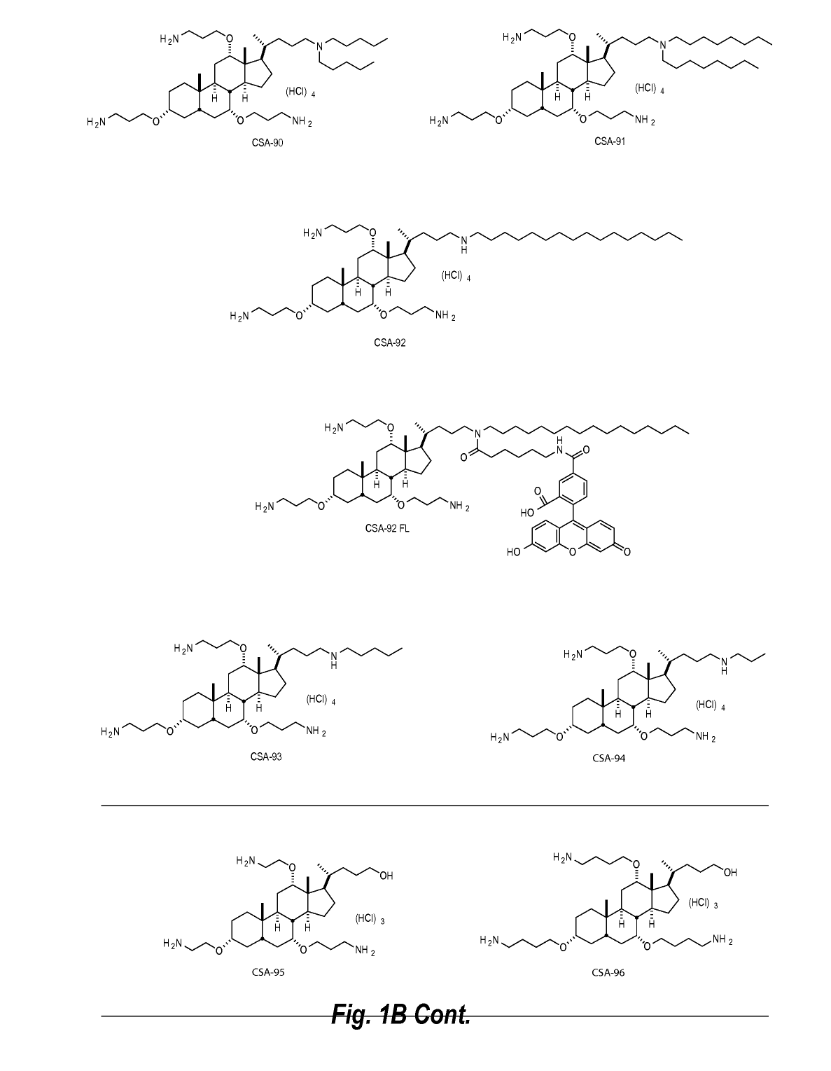

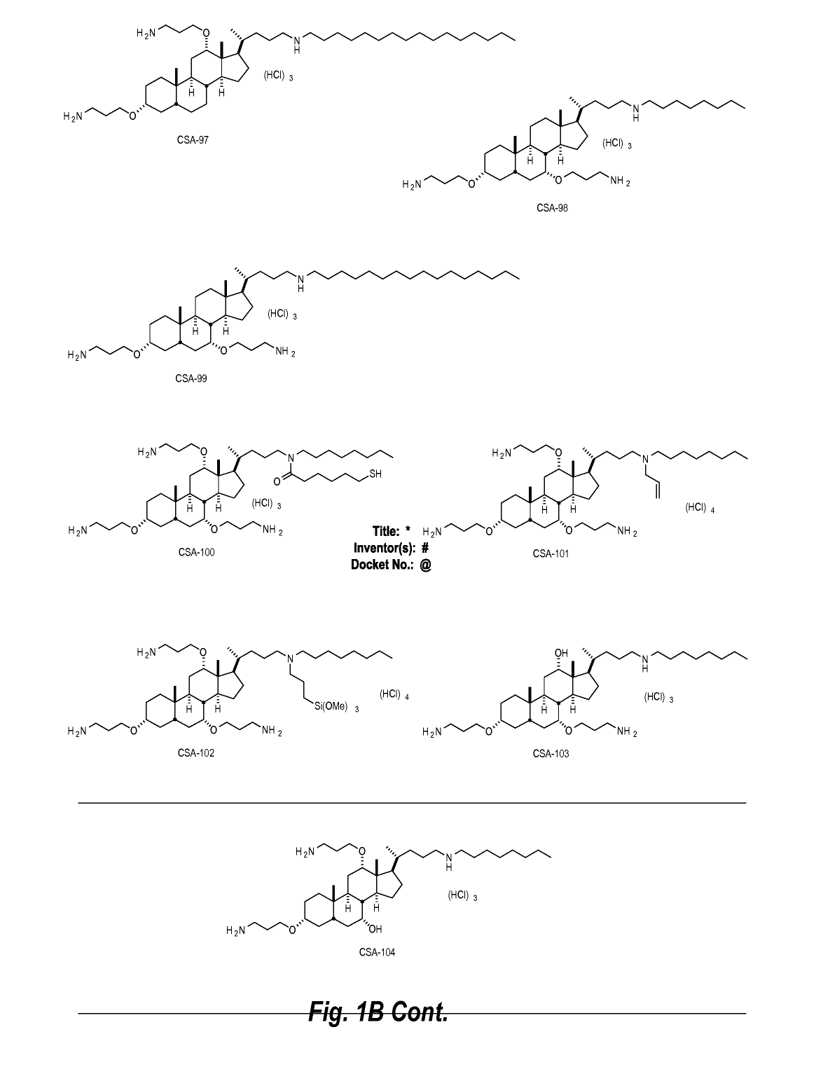

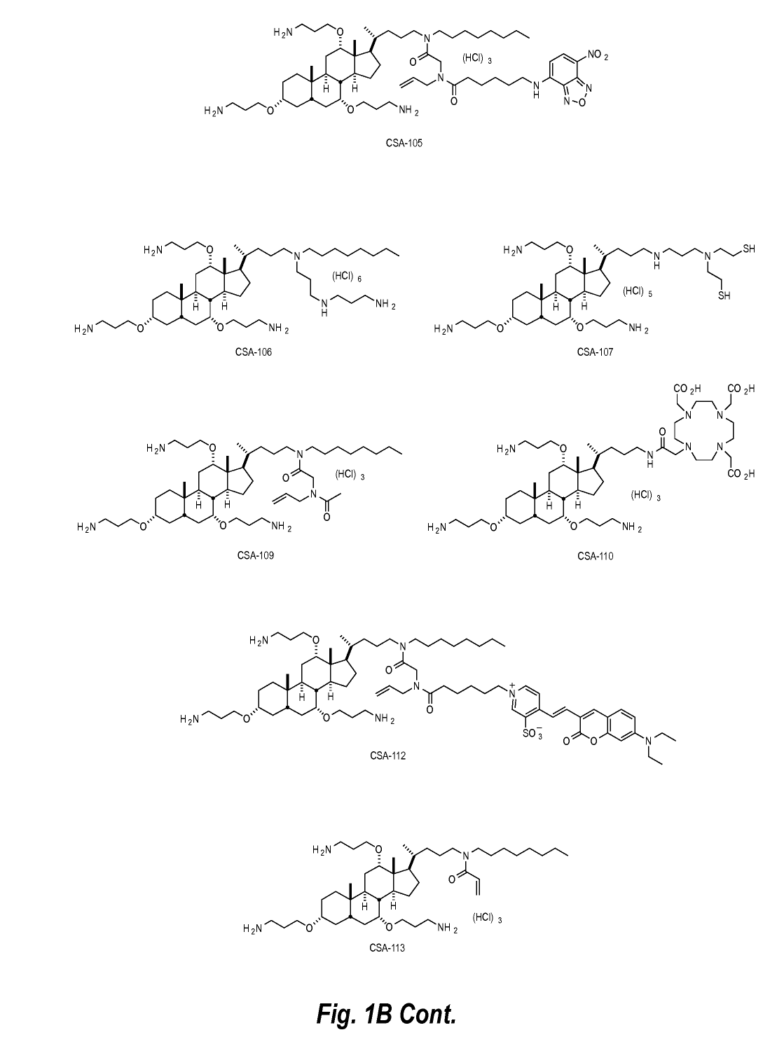

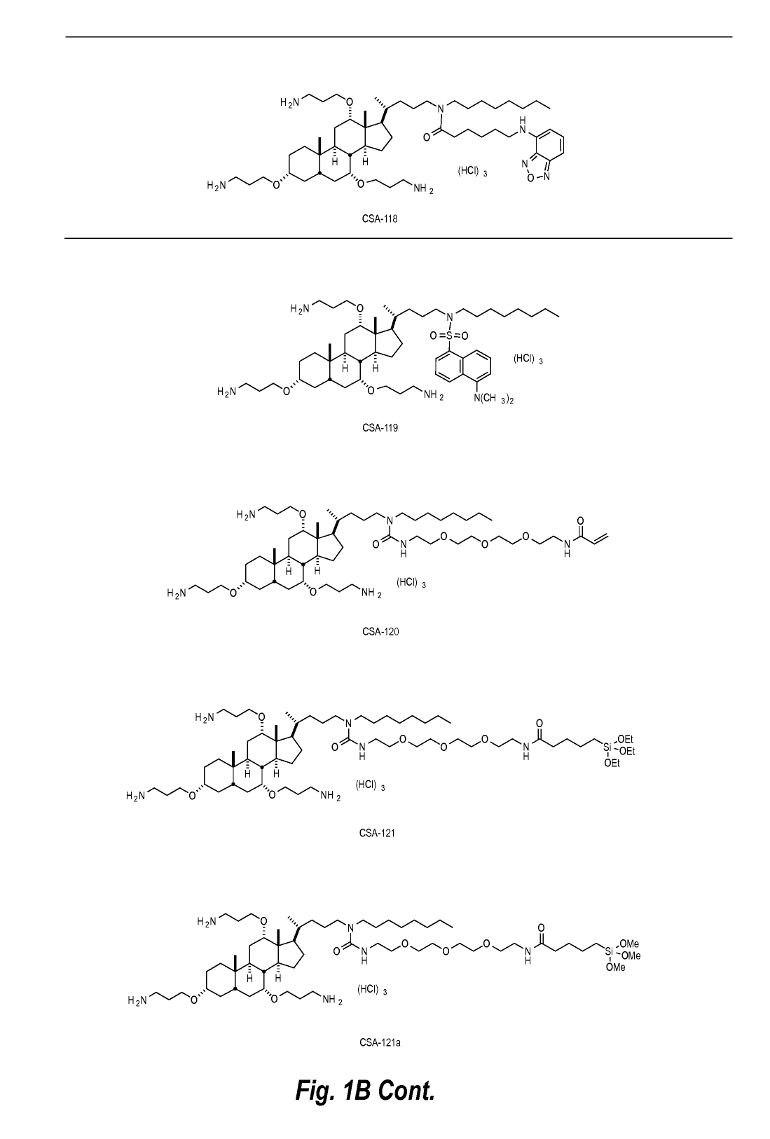

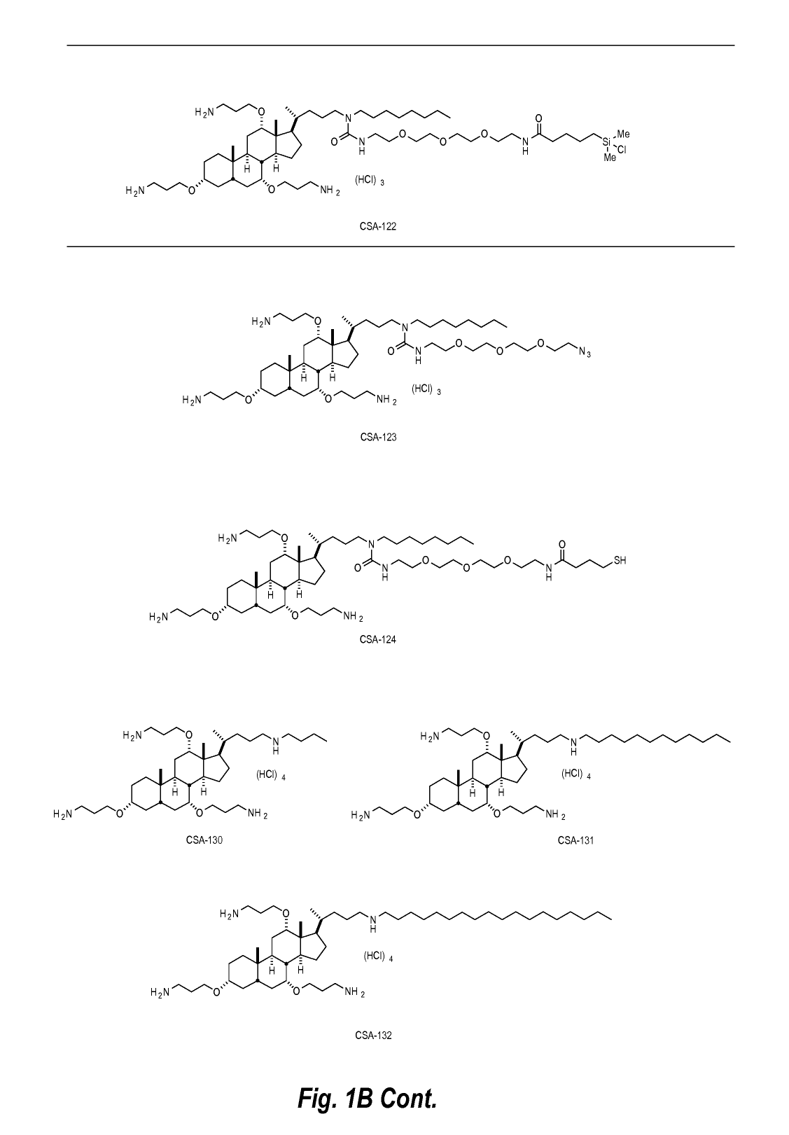

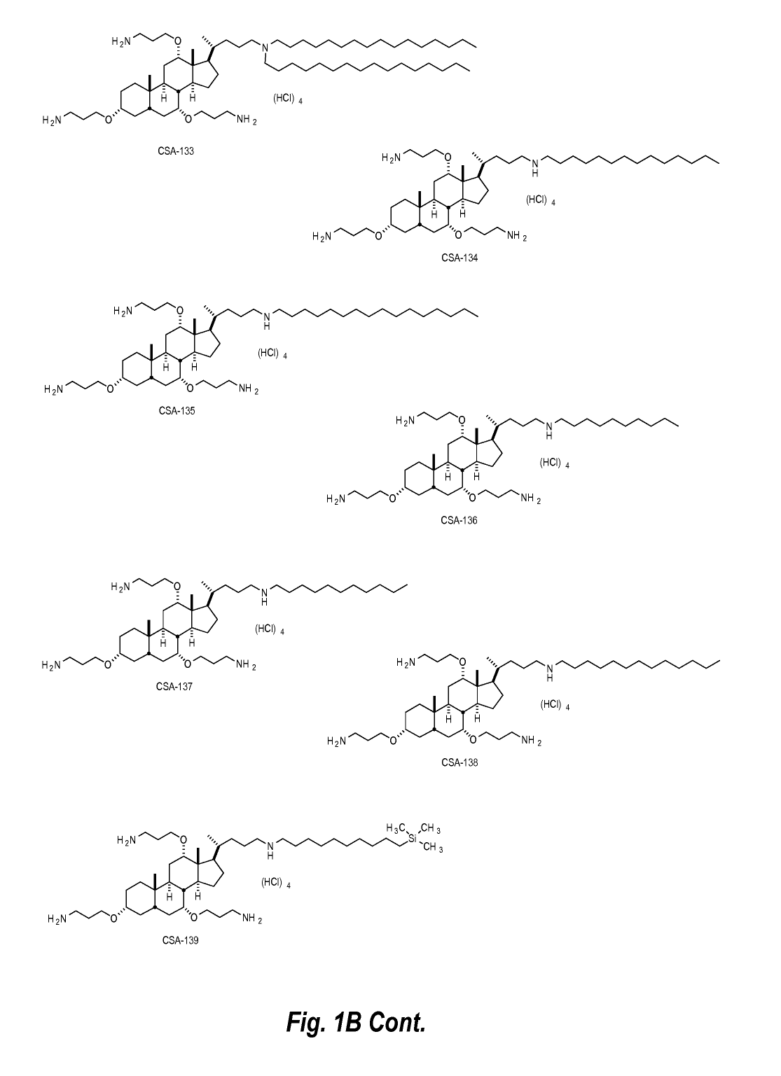

A number of examples of ceragenin compounds of Formula I that can be incorporated into the wash compositions described herein are illustrated in FIGS. 1A-1B.

Typically, ceragenins of Formula I are of two types: (1) ceragenins having cationic groups linked to the sterol backbone with hydrolysable linkages and (2) ceragenins having cationic groups linked to the sterol backbone with non-hydrolysable linkages.

Ceragenins of the first type can be “inactivated” by hydrolysis of the linkages coupling the cationic groups to the sterol backbone. For example, one type of hydrolysable linkage is an ester linkage. Esters are hydrolyzed in the presence of water and base. Ceragenins of the first type are desirable, for example, where it is preferred that the ceragenins break down so that they do not buildup in the environment.

Similarly, this may also serve as a safety mechanism to prevent or minimize ingestion of the compounds by an end user consuming a meat food product treated with the ceragenin compound. For example, the compound may degrade simply as a result of environmental conditions (e.g., pH) within a matter of weeks. Because the compounds can also be inactivated through cooking, this also serves as another safety mechanism to prevent or minimize their ingestion. Of course, not all food products, particularly plant sourced food products, are cooked prior to eating. Advantageously, the compounds have also been found to be inactivated by lipase enzymes present within the stomach, so that even if one were to ingest residual ceragenin compound, it would be destroyed within the stomach, preventing any buildup within the body of the consumer.

Finally, it has also been found that the concentration of ceragenin required to kill beneficial bacteria residing within the digestive tract of humans is approximately 50 times greater than the concentration required to kill illness causing bacteria such as Salmonella and Campylobacter. Thus, this characteristic provides yet another level of protection to prevent something akin to an antibiotic flush (i.e., killing essentially all bacteria within the digestive system of a person) if any residual ceragenin compound were somehow ingested through consumption of a fruit, vegetable, or other non-meat food product treated with the present wash compositions.

Ceragenins of the second type are not inactivated by hydrolysis. While their stability may be less preferred in the specific context of anti-microbial wash compositions, the use of such ceragenin compounds is within the scope of the present invention. While such ceragenin compounds may not be degraded through environmental conditions that lead to hydrolysis, at least some of these ceragenin compounds may be subject to the other safety features described above (i.e., destruction through cooking, inactivation by action of stomach lipase, and their characteristic of selectively killing illness causing bacteria while posing no threat to beneficial bacteria at a given concentration). Further, such ceragenin compounds may be rinsed off the food product prior to delivery to the end consumer.

Depending at least in part on the class of ceragenin compound selected, the ceragenin used in the wash compositions described herein may be selected to be shelf stable for days, weeks, months, or even years after the wash composition is prepared. Hydrolysable ceragenin compounds exhibiting relatively short term stability (e.g., a half life of several weeks) can be stabilized by the addition of an acid to the carrier, providing shelf life that is as long as desired (e.g., up to months or perhaps even years). That said, typically, the wash composition may be prepared on site (e.g., at a food processing facility) and stored while the prepared volume is being used (e.g., over a period of a few weeks or months). In addition, the relatively short-term stability of the hydrolysable ceragenin compounds may serve as a desirable advantage, providing protection for the desired period of time (e.g., from harvest to delivery to an end consumer) while at the same time providing for automatic degradation of the ceragenin compound into inert, naturally occurring degradation products. This minimizes risk of ingestion by an end user and also minimizes risk of buildup of such compounds within the environment (e.g., when spent wash composition is discarded). To provide even further minimization of ingestion risk, the food product may be rinsed just prior to delivery to the end consumer.

A number of examples of compounds of Formula I that may be used in the embodiments described herein are illustrated in FIGS. 1A-1B. Suitable examples of ceragenins with hydrolysable linkages include, but are not limited to CSA-27, CSA-28, CSA-29, CSA-30, CSA-31, CSA-32, CSA-33, CSA-34, CSA-35, CSA-36, CSA-37, CSA-41, CSA-42, CSA-43, CSA-44, CSA-45, CSA-47, CSA-49, CSA-50, CSA-51, CSA-52, CSA-56, CSA-61, CSA-141, CSA-142, and combinations thereof. In a preferred embodiment, a hydrolysable ceragenin compound is CSA-44. Besides being hydrolysable, CSA-44 also has the advantage that degradation products resulting from its inactivation or destruction are compounds that are found within nature and within the body already. This feature is particularly beneficial as there is little if any risk thus associated with accidental or even other ingestion of contemplated concentrations of CSA-44, or with inactivation of CSA-44 within the body of the end user (e.g., through action of lipase). At least some of the ceragenin compounds other than CSA-44 may also share these same characteristics.

Examples of ceragenins with non-hydrolysable linkages include, but are not limited to, CSA-1-CSA-26, CSA-38-CSA-40, CSA-46, CSA-48, CSA-53-CSA-55, CSA-57-CSA-60, CSA-90-CSA-107, CSA-109, CSA-110, CSA-112, CSA-113, CSA-118-CSA-124, CSA-130-CSA-139, and combinations thereof. A combination of hydrolysable and non-hydrolysable CSAs may also be employed. Additional details relating to ceragenin compounds are described in section V below.

### II. Anti-Microbial Wash Compositions

In one embodiment, an anti-microbial wash composition for controlling growth of microbes on vegetables, fruits, grains, eggs, or other non-meat food products is described. The composition includes a fluid carrier and a ceragenin compound dispersed in the carrier. The ceragenin compound has a sterol backbone and a number of cationic groups attached thereto.

In one embodiment, the cationic groups are attached to the sterol backbone by hydrolysable linkages, which may be ester linkages. Such linkages are generally unstable in the presence of water and can be cleaved by water in a base catalyzed reaction. The relative instability of the ceragenin compound is desirable it at least some embodiments of the wash composition, as it provides a mechanism for natural, automatic degradation of the ceragenin compound so as to provide protection while the ceragenin remains potent, but to also limit ingestion of the ceragenin by an end user. By way of example, a hydrolysable ceragenin (e.g., CSA-44) in a water carrier having a pH of 7 exhibits a half life of about 37 days.

If desired, the stability of the wash composition may be prolonged by including an acid so that the pH of the wash composition is acidic (e.g., a pH of 6 or less, or a pH of 5.5 or less) and thus stabilized prior to use. Once such a wash composition is applied, the pH will typically increase as a result of basic components present within the application environment (e.g., on the meat food product), leading to destabilization and eventual degradation of the hydrolysable ceragenin compounds.

Whether hydrolysable or non-hydrolysable ceragenin compounds are employed in the wash composition, the selected ceragenin compound(s) may be dispersed in essentially any suitable fluid carrier. In typical embodiments, the fluid carrier will comprise a liquid, although it may also be possible to disperse the ceragenin compound(s) in a gaseous carrier (e.g., air, nitrogen, a noble gas, etc.) which can then be applied to a plant sourced or other non-meat food product in order to control microbe growth on the food product. For example, when treating grains, it may be desirable to contact the grains with a gaseous blanket anti-microbial wash composition including the ceragenin compound suspended within a gaseous carrier. Such embodiments may be beneficial so as to alleviate issues with drying the grain post treatment. Other food products, such as fruits (e.g., apples, oranges, bananas, pears, tomatoes, strawberries, etc.), vegetables (e.g., peppers, carrots, lettuce, cabbage, onions, potatoes, etc.), and eggs may be treated by contacting them with an anti-microbial wash composition including a liquid carrier. Water is a particularly preferred liquid carrier. Suitable other liquid carriers include, but are not limited to, alcohols, oils, organic solvents, organic/aqueous emulsions, and combinations thereof.

Although it may be possible to disperse the ceragenin compound(s) in a thick, viscous carrier such as petroleum jelly, it is preferred that the carrier be of relatively low viscosity (e.g., less than about 100 cps) so that the wash composition can be more easily sprayed onto the food product, or the food product may be dipped into the wash composition. Relatively low viscosity carriers and resulting wash compositions will more easily coat and cover the surface of the meat food product. In one embodiment, the viscosity of the composition is not more than about 10 cps. In another embodiment, the viscosity is not more than about 1 cps (the viscosity of water). Relatively low viscosity wash compositions will more easily drain away under force of gravity from the food product following wash application, are more easily sprayed, and are more easily employed where the food product is immersed or otherwise dipped into a bath of the wash composition.

In one embodiment, the majority (i.e., more than 50%) of the wash composition comprises water. In some embodiments, water may comprise the vast majority of the wash composition (e.g., about 75% to about 99% or more by weight). In one embodiment, the wash composition may consist of the ceragenin compound in water.

In one embodiment, the carrier may include a surfactant to enhance the wetting properties of the composition (i.e., aid in providing full coating and coverage of the surface of the food product). Suitable examples of surfactants include, but are not limited to, anionic surfactants (e.g., sodium lauryl sulfate and alkylbenzenesulfonates), cationic surfactants (e.g., CTAB), zwitterionic surfactants (e.g., CHAPS), and nonionic surfactants (e.g., Triton-X series detergents and polyethylene glycol monoalkyl ethers). The anti-microbial compositions described herein can also include one or more non-surfactant additives (e.g., EDTA, phosphonic acids, phosphinic acids, and the like). Such additives can, for example, enhance the wetting properties of the above described surfactants and/or chelate metals (e.g., copper, iron, magnesium, and the like), which may have mild anti-microbial effect.

As described above, in one embodiment, particularly where a hydrolysable ceragenin is included within the wash composition, the carrier may includes an acid if it is desired to prolong the stability of the ceragenin. In one embodiment, the acid is added to the carrier in an amount sufficient to reduce the pH of the carrier with the ceragenin compound dispersed therein to a pH of about 6 or less, or about 5.5 or less. Suitable examples of acids that can be used to adjust the pH of the carrier include, but are not limited to, acetic acid, peracetic acid, citric acid, ascorbic acid, hydrochloric acid, sulfuric acid, nitric acid, and combinations thereof. In a specific embodiment, the acid is acetic acid added to the carrier at a concentration in a range from about 0.01% to about 1% (v/v) (e.g., about 0.5% (v/v)).

As described, a preferred embodiment may include a ceragenin compound that is specifically selected to by hydrolysable, while also being formulated in a carrier such as water without any acid, so that the pH is about 7. Such anti-microbial wash compositions may be specifically formulated to provide relatively fast degradation of the ceragenin compound, so that the composition is prepared on site, and shortly thereafter applied to the surface of the non-meat food product (e.g., just after harvesting). Because the ceragenin compound degrades quickly, this further reduces any risk that the compound might be ingested by a person thereafter consuming the non-meat food product, even if the food (e.g., fruits or vegetables) is not cooked or even rinsed before eating.

Preferably, the food product may be rinsed just before delivery to the end consumer. For example, the ceragenin containing wash composition exhibiting a half-life of less than about 40 days may be applied just after harvest. For many produce food products, the period of time from harvest to delivery to the end consumer may be a period of several weeks, which is particularly well suited to the stability of the above described ceragenin compounds. The ceragenin compound may thus provide continuing antimicrobial protection to the food product during shipment, prior to delivery to the end consumer. By the time of delivery to the end consumer, only about half of the original ceragenin compound concentration may remain. Furthermore, after shipping and just prior to delivery to the end consumer, the food product may be rinsed to remove residual ceragenin compound from the food product. Such a combination of features reduces any risk of ingestion of the ceragenin by an end user, while also providing improved antimicrobial protection during shipping, which may last several weeks.

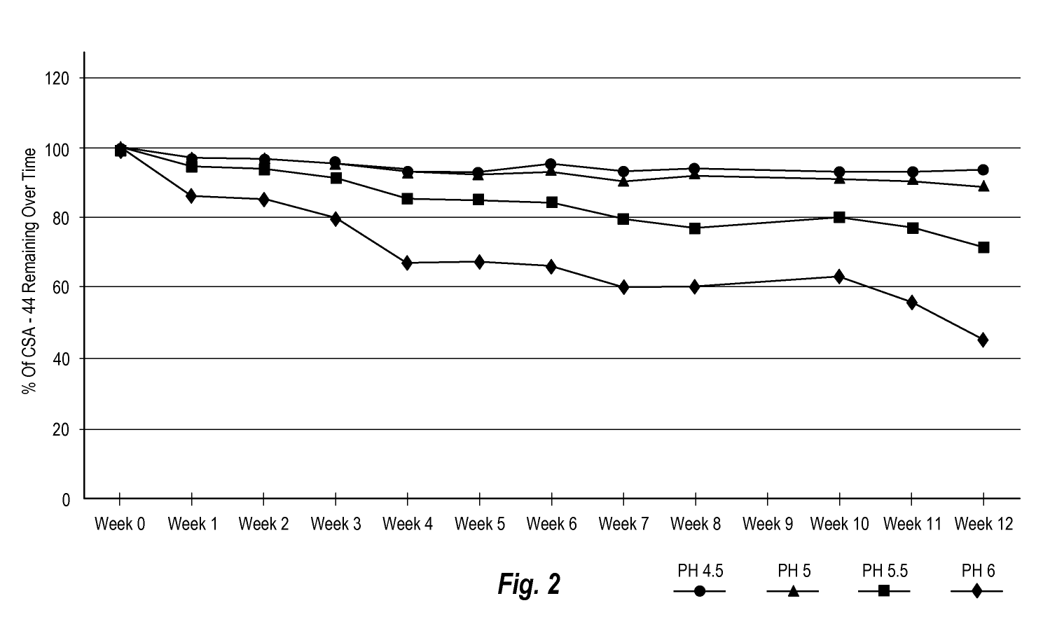

FIG. 2 and Table 1 illustrates the stability of CSA-44, a preferred hydrolysable ceragenin, in aqueous solution as a function of pH. CSA-44 includes three ester-linked terminal amine groups attached at the R₃, R₇, and R₁₂ positions of Formula I. CSA-44 is illustrated in FIG. 1A. As can be seen from FIG. 2, the stability of CSA-44 increases with decreasing pH.

TABLE 1
CSA-44 Stability as a function of pH

| Week | pH 6 | pH 5.5 | pH 5 | pH 4.5 |
|---|---|---|---|---|
| Week 0 | 100 | 100 | 100 | 100 |
| Week 1 | 86.3 | 94.8 | 97.5 | 97.2 |
| Week 2 | 85.5 | 94.6 | 97.4 | 97.0 |
| Week 3 | 80.3 | 92.3 | 96.4 | 96.7 |
| Week 4 | 67.6 | 86.3 | 94.3 | 94.1 |
| Week 5 | 68.1 | 86.0 | 94.2 | 93.0 |
| Week 6 | 66.9 | 85.5 | 94.9 | 96.8 |
| Week 7 | 60.6 | 80.9 | 91.8 | 94.5 |
| Week 8 | 60.9 | 77.8 | 93.8 | 95.6 |
| Week 9 | N/A | N/A | N/A | N/A |
| Week 10 | 64.0 | 81.2 | 92.6 | 94.7 |
| Week 11 | 56.3 | 78.2 | 92.1 | 94.6 |
| Week 12 | 45.4 | 72.4 | 90.1 | 95.2 |

In embodiments where a short shelf-life is desired, pH values higher than that shown in the table may be employed (e.g., about 6, 6.5, or 7). Such embodiments may specifically exclude an acid from the carrier. Such compositions may also degrade even more quickly following application due to environmental conditions, as the pH may rise more quickly in the application environment. In one embodiment, the ceragenin compound has a half-life of from about 20 days to less than about 40 days. For example, the inventor in the present case has found that CSA-44 has a half-life of about 37 days at pH 7.

The half-life of the ceragenin compounds described herein is likely to be shorter at higher pH. In addition, even though the ceragenin compounds described herein are not metabolized in the process of killing microbes, they are effectively inactivated when they are absorbed into the membrane of a microbe. As a result, the effective half-life of hydrolysable ceragenin compounds described herein (e.g., CSA-44) are likely to be substantially shorter in a microbe-contaminated environment. Furthermore, there are additional safeguards to preventingestion or harm to the end user as described above (i.e., removal by washing prior to delivery, destruction or inactivation through cooking, destruction or inactivation as a result of lipase enzymes within the stomach, and the fact that the employed concentrations are too low to kill beneficial bacteria within the intestines or other digestive system areas even if ingested). Finally, the products resulting from inactivation or destruction of the ceragenin, at least in the case of CSA-44, are compounds that are normally found within the body anyway.

In one embodiment, the carrier may include a buffer. Such a buffer may be present in a buffer concentration of less than 1 molar (“M”), 500 millimolar (“mM”), 100 mM, 75 mM, 50 mM, 25 mM, 10 mM, or 5 mM or less. In another embodiment, the carrier is substantially unbuffered. The buffering capacity of the carrier can affect the ability of a fruits, vegetables, or other non-meat food product surface to raise or lower the pH of the ceragenin compound after it is applied to the surface. This may aid in providing more consistent half-life characteristics independent of the application conditions (e.g., the surfaces of some food products may be more acidic or more basic than others).

In one embodiment, the ceragenin compound may have a structure as shown in Formula I. In Formula I, at least two of R₃, R₇, or R₁₂ may independently include a cationic moiety attached to the Formula I structure via a hydrolysable (e.g., an ester) or non-hydrolyzable linkage (e.g., an ether O-heteroatom linkage). Optionally, a tail moiety may be attached to Formula I at R₁₇. The tail moiety may be charged, uncharged, polar, non-polar, hydrophobic, amphipathic, and the like.

Suitable examples of ceragenin compounds of Formula I that have hydrolysable linkages include, but are not limited to, CSA-27, CSA-28, CSA-29, CSA-30, CSA-31, CSA-32, CSA-33, CSA-34, CSA-35, CSA-36, CSA-37, CSA-41, CSA-42, CSA-43, CSA-44, CSA-45, CSA-47, CSA-49, CSA-50, CSA-51, CSA-52, CSA-56, CSA-61, CSA-141, CSA-142, and combinations thereof (see FIG. 1A). Preferred hydrolysable ceragenin compounds of Formula I include one or more of CSA-32, CSA-33, CSA-34, CSA-35, CSA-41, CSA-42, CSA-43, CSA-44, CSA-45, CSA-47, CSA-49, CSA-50, CSA-51, CSA-52, CSA-56, CSA-141, CSA-142, and combinations thereof. CSA-44 is a particularly preferred hydrolysable ceragenin compound of Formula I.

Examples of ceragenin compounds of Formula I that have non-hydrolysable linkages include, but are not limited to, CSA-1-CSA-26, CSA-38-CSA-40, CSA-46, CSA-48, CSA-53-CSA-55, CSA-57-CSA-60, CSA-90-CSA-107, CSA-109, CSA-110, CSA-112, CSA-113, CSA-118-CSA-124, CSA-130-CSA-139, and combinations thereof (see FIG. 1B).

The anti-microbial activity of the ceragenin compounds can be affected by the orientation of the substituent groups attached to the backbone structure. In one embodiment, the substituent groups attached to the backbone structure are oriented on a single face of the ceragenin compound. Accordingly, each of R₃, R₇, and R₁₂ may be positioned on a single face of Formula I. In addition, R₁₇ may be positioned on the same single face of Formula I.

In one embodiment, the fluid carrier includes an alcohol. Exemplary alcohols include lower alcohols (e.g., C₁-C₄ alcohols) such as ethanol, propanol, isopropanol, and combinations thereof. One particular example of a carrier includes water, an alcohol, and a surfactant.

The ceragenin compound(s) are included in an amount to be effective in killing microbes on the surface of a non-meat food product. In one embodiment, the ceragenin compound(s) are included in an amount in a range from about 10 ppm by weight to about 1000 ppm by weight of the anti-microbial wash composition. Preferably, the ceragenin compound(s) comprise from about 25 ppm by weight to about 500 ppm by weight. More preferably, the ceragenin compound(s) comprise from about 50 ppm by weight to about 500 ppm, or about 50 ppm to about 200 ppm by weight. In one embodiment, the ceragenin compound comprises at least about 25 ppm by weight, or at least about 50 ppm by weight of the wash composition. Furthermore, in one embodiment, the ceragenin compound comprises not more than about 1000 ppm, or not more than about 500 ppm by weight of the wash composition.

### III. Methods Of Killing Microbes On A Non-Meat Food Product

According to one aspect, the present invention is directed to methods of killing and controlling growth of microbes on a non-meat food product, such as fruits, vegetables, grains, and eggs. The method includes (1) applying the above described anti-microbial wash compositions to a surface of a non-meat food product that may be exposed to one or more microbes and (2) killing one or more types of microbes on the surface of the food product. The anti-microbial wash compositions may be effective in killing multiple types of microbes (e.g., a wide variety of different bacterial strains). As described above, the ceragenin compound has a sterol backbone and a number of cationic groups attached thereto and is dispersed within a fluid carrier.

The anti-microbial wash composition may be applied to any of various non-meat food products. The wash composition may be applied to any contemplated non-meat food products, such as, but not limited to, fruits, vegetables, grains, eggs, etc. Other examples of non-meat products that may be treated will be apparent to one of skill in the art in light of the present disclosure.

In one embodiment, the anti-microbial wash composition may be applied to the outside surface of fresh produce (e.g., whole fruits, or whole vegetables), whole eggs, or other non-meat food products. In other embodiments, in which such food products are cut or otherwise processed, because of the safety features described herein that minimize any risk associated with ingestion of the ceragenin compounds, the anti-microbial wash compositions may be applied to cut or otherwise prepared internal surfaces of such food products. For example, the composition may be applied to cut apples, other cut fruits, or cut vegetables, whether such food products are being prepared for sale as fresh produce or being canned, bottled, or otherwise packaged within cans, bottles, or other containers.

In one embodiment, the wash composition may be applied more than once, for example, at different stages of processing the fruit, vegetable, or other non-meat food product. For example, a first application of the wash composition may be done to fruits, vegetables, eggs, or other non-meat food products soon after harvest, prior to any significant processing, while another application may be done later, once such fruits, vegetables, or other non-meat food products have been cut or processed into another form prior to packaging. Both such applications may be prior to a relatively lengthy shipping period (e.g., several weeks) that may occur prior to delivery to the end consumer. By way of another example, two applications of a wash composition may be made, with the concentration of the ceragenin compound in the first wash composition being different than that of the second wash composition. For example, a first application may be at a higher ceragenin concentration than the second application to provide an initial “hit” followed by a second dosing.

As described above, one simple mechanism to limit risk of ingestion of the ceragenin compound is to apply a wash composition including a degradable ceragenin compound prior to shipping of the food product, and then to rinse the food product prior to delivery or sale to the end consumer. For example, for many produce food products (e.g., tomatoes and other fresh fruits and vegetables), there may be a time period of several weeks (e.g., about 2-6 weeks, or about 3-5 weeks) between harvest and delivery to the end consumer. A wash composition including a hydrolysable ceragenin in a water carrier might exhibit a half-life of less than about 40 days, so that the majority of the ceragenin applied soon after harvest may provide antimicrobial protection during shipping, but may have largely degraded by the time of delivery to the end consumer. In one embodiment, the food product may be rinsed prior to such delivery to further remove any residual ceragenin compound from the food product. Such a combination of features reduces any risk of ingestion of the ceragenin by an end user, while also providing improved antimicrobial protection during shipping, which may last several weeks.

In one embodiment, the wash composition is applied at a particular stage during processing of the food product only once. The present ceragenin containing wash compositions can be effective in as little as a single application. Of course, additional applications may be employed, if desired. In at least some embodiments, the anti-microbial wash compositions provide more than just a rinsing action in which microbes are simply washed off the surface of the food product. Rinsing action may be provided by the carrier (e.g., water), although the ceragenin of the wash compositions are also capable of actually killing microbes on the surface of the food product. This is a distinct advantage over state of the art chlorine wash treatments, which only act to physically rinse such microbes off the food product and into the wash composition. The chlorine merely serves to prevent bacterial build-up within the wash water. In this sense, state of the art chlorine wash compositions typically do not provide any better microbe count reduction than that provided by simple washing with clean water.

In one embodiment, the ceragenin compound in the anti-microbial wash composition may remain capable of continuing to kill microbes on the surface of the food product for at least one day after the application, at least 5 days after the application, or at least 10 days after the application. At the same time, the ceragenin compound may also degrade due to environmental conditions within a matter of days or weeks (e.g., a half-life of less than about 40 days). This provides the treated food product with some level of prospective resistance to microbial contamination, while also reducing any risk that the ceragenin might be ingested by the end user.

For example, upon application, microbes present on the food product are killed. In addition, residual amounts of the ceragenin compound(s) of the wash composition may remain on the surface of the food product if not washed away by the carrier. Such residual ceragenins remain active, and able to kill microbes should a microbe be transferred to the surface of the food product or otherwise begin to grow on the surface of the food product (i.e., a contamination event). Thus, the residual ceragenin is capable of remaining on the food product surface in an active state, ready to kill any microbe that should begin to grow thereon.

At the same time, a hydrolysable ceragenin begins to degrade immediately after application, so that there is reduced risk of ingestion by the end user at the time of consumption of the non-meat food product. This is particularly so if the food product is rinsed after shipping and before delivery to the end consumer to remove any residual ceragenin compound, cooked following treatment, either by the end user or as part of providing a food product to the consumer (e.g., cooked during canning). As a further protective characteristic, even if some residual ceragenin were not destroyed by environmental conditions or cooking, at least some of the ceragenin compounds (e.g., CSA-44) are destroyed by lipase enzymes found in the stomach.

Finally, even if some ceragenin were to survive through the stomach, the concentration of ceragenin required to kill beneficial bacteria found within the intestines and other digestive tract locations is significantly higher (e.g., about 50 times higher) than that required to kill illness causing bacteria, such as Salmonella and Campylobacter. Thus, the concentration of ceragenin compound selected in the wash compositions is sufficient to kill illness causing bacteria without being high enough to kill beneficial bacteria. Each of these features thus represents a layer of safety protection to minimize or prevent any undesirable effects associated with ingestion or use of the wash compositions. Where two or more such safety features are provided by a given ceragenin compound, there is little if any risk of any undesirable side effects to an end user. CSA-44 is preferred as providing every one of these safety features.

Another advantageous characteristic associated with the ceragenin containing wash compositions is their effectiveness in killing biofilm type bacteria, in addition to planktonic bacteria. Many other anti-microbial agents, including nearly all or all antibiotics, are not capable of effectively killing bacteria present as a biofilm. This is believed to be due to the fact that such antibiotics attack enzymes associated with growth of bacteria. Biofilm bacteria are believed to be in something of a sessile state so that the targeted growth enzymes are not being produced. This results in the biofilm bacteria surviving an antibiotic treatment, meaning they are capable of continuing to pose a pathogenic threat even after such antibiotic treatment. The ceragenin compounds operate through a different mechanism, which is effective against both planktonic and biofilm type bacteria.

The inventors have found that the ceragenin compounds described herein can be applied to a variety of non-meat food products to kill bacteria and the like and thereby prevent or delay spoilage and/or prevent transmission of food borne illness. To great advantage over existing anti-microbial wash compositions (e.g., chlorine containing washes), at the concentrations needed for food application, the ceragenin compounds described herein are tasteless, odorless, safe for human consumption (although ingestion is unlikely as described above), and do not negatively affect the appearance (e.g., color), texture, taste, smell, and other quality characteristics of the meat or other food product. Furthermore, they are more effective than chlorine containing washes, as they act to actually kill bacteria on the food product surface, rather than merely washing such bacteria off the food product and into the wash composition.

The ceragenin compounds are selective in that they are able to attack a wide variety of dangerous illness causing microbes on the non-meat food product surface without any significant effect on the food product itself. This is in contrast to wash compositions including an oxidizer such as chlorine, which are not selective and may tend to oxidize the food product itself. Because ceragenin compounds are able to kill bacteria on the food product surface, and are selective, this allows a ceragenin treated food product to actually fight off a new bacterial contamination event because of residual ceragenin compound present on the food product surface, even after treatment is completed.

The present invention also relates to the products produced from the methods described herein. The products treated using the methods described herein can be made safer for consumption. In addition to having a lower microbial population, the products are more resistant to microbial colonization. This resistance is achieved with very low concentrations of CSA on the meat. Unlike traditional washes such as acid washes, the methods of the present invention produce products that resist microbial colonization over extended periods of time (e.g., 5, 10, 15, 20, 30 days) as compared to products produced using traditional methods. Thus, the products produced using these methods are unique as compared to products produced using traditional methods.

### IV. Examples

### Example 1

A study was performed to determine the effectiveness of an anti-microbial rinse composition including relatively low concentrations of a ceragenin compound in controlling growth of bacteria and extending shelf-life of a food product. Three different wash compositions were prepared. Aqueous wash composition 1 (the control) included no ceragenin compound or other anti-microbial agent. Aqueous wash composition 1 was simply tap water. Aqueous wash composition 2 included a 50 ppm ceragenin compound concentration by weight in tap water, and had a pH of 6.5. Aqueous wash composition 3 included a 100 ppm ceragenin compound concentration by weight in tap water, and had a pH of 6.5. The ceragenin compound employed was CSA-44. A food product was dipped (e.g., immersed) for 30 seconds into the given wash composition and mechanically agitated to mimic the action of a finishing chiller used in commercial processing. After the 30 second application time, the dipped food products were immediately vacuum packaged and stored in a refrigerator at 4° C. Three samples from each treatment were tested every third day beginning at day 0 and ending at day 21 to monitor their associated levels of microorganisms.

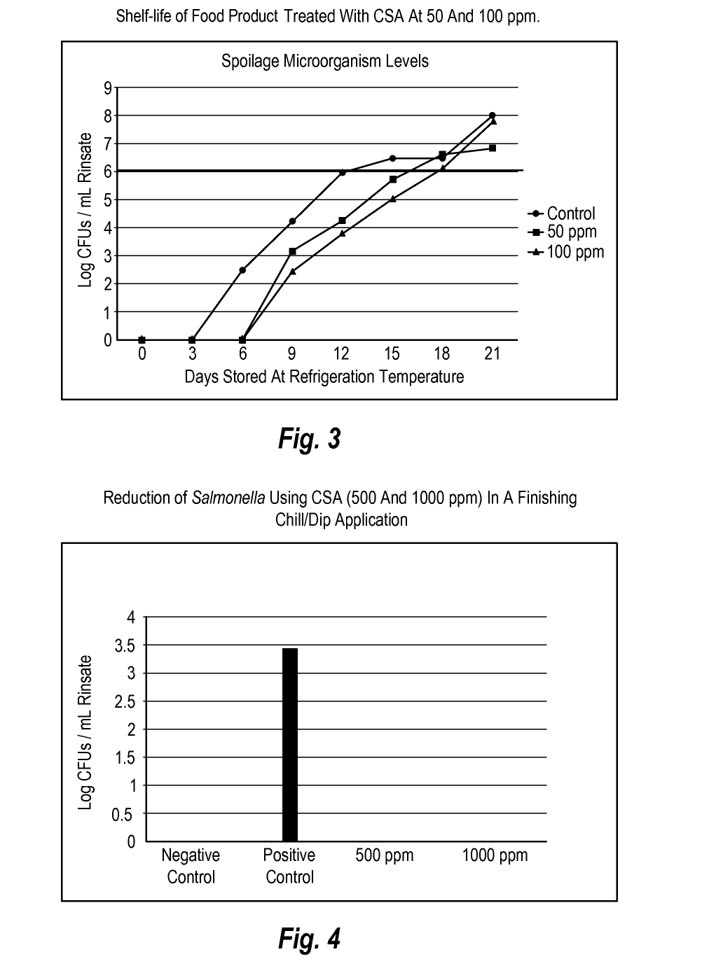

The results are presented in FIG. 3. The particular food product tested is considered to be spoiled when it reaches a level of 10⁶ Colony Forming Units (“CFUs”)/ml of spoilage microorganisms in the rinsate. The control, i.e., food product samples treated with wash composition 1, reached this limit on day 12. By day 15, the food product samples treated with wash compositions 2 and 3 still had not reached this limit. By day 18, the food product samples treated with wash composition 2 had exceeded this limit with a value of about 10^{6.5} CFUs/ml. By day 18, the food product samples treated with wash composition 3 had just reached the 10⁶ CFUs/ml limit. Thus, even with a relatively low ceragenin compound concentration (e.g., 50 ppm or 100 ppm), significant increases in shelf-life (e.g., more than 3 days and 6 days, respectively) were achieved relative to the use of no anti-microbial agent.

By way of comparative example, shelf life-extension characteristics of wash compositions including chlorinated aqueous washes typically result in no extension of shelf-life relative to wash compositions that consist of a water rinse, with no anti-microbial agent at all. Thus, the use of ceragenin compound containing wash compositions may be characterized by a 3 to 6 day increase in the shelf-life of a food product.

It is also noted that no detectable changes in quality characteristics of the food product were observed as a result of application of wash compositions 2 and 3. In other words, there were no changes to color, texture, taste, or smell, as a result of application of the ceragenin wash compositions. This is in contrast to treatment with aqueous chlorinated wash compositions, which can result in changes to these characteristics.

### Examples 2-3

Example 2 was performed to determine the effectiveness of an anti-microbial wash composition including a ceragenin compound in controlling growth of Salmonella bacteria by fighting off a Salmonella inoculation. Example 3 was similarly performed to determine the effectiveness of the wash composition in controlling growth of Campylobacter bacteria by fighting off a Campylobacter inoculation. Examples 2 and 3 simulate the effectiveness of the present anti-microbial wash compositions to kill Salmonella and Campylobacter on a food product where the food product has become contaminated with Salmonella bacteria or Campylobacter bacteria.

A total of 15 food product samples were used for these tests. The 15 samples were divided into five groups of three each. Three samples were left untreated to serve as a negative control in order to observe natural levels of bacteria present on the samples. The remaining 12 samples were then inoculated with 1 mL of Salmonella and 1 mL of Campylobacter. The samples were allowed to dry for 20 minutes in order for the bacteria to adhere to the surface of the food product samples. One group of three of the inoculated samples, designated the positive control, were then rinsed with a wash composition including no anti-microbial agent to determine the level of bacteria after inoculation.

One group of three inoculated samples was dipped one by one into 3 gallons of an aqueous wash composition including a ceragenin concentration (CSA-44) of 500 ppm by weight. Each sample was withdrawn after 30 seconds. Another group of three inoculated samples was dipped one by one into 3 gallons of an aqueous wash composition including a ceragenin concentration (CSA-44) of 1000 ppm by weight. Each sample was withdrawn after 30 seconds. The fifth group of three inoculated samples was dipped one by one into a comparative proprietary non-CSA wash composition. Each of the samples was then rinsed, and the rinsate was collected to determine the levels and types of bacteria from each group. While the samples treated with the ceragenin wash compositions were “slick” following treatment (similar to a product treated with a surfactant), there were no observable changes in quality characteristics of the food product following treatment. In other words, there were no changes to color, texture, taste, or smell, as a result of application of the ceragenin wash compositions. This is in contrast to treatment with chlorinated wash compositions, which can result in changes to at least color and smell of the product.

FIG. 4 shows the results for Salmonella bacteria. The negative control showed no detectable Salmonella bacteria. The positive control showed a level of nearly 10^{3.5} CFUs/mL of Salmonella in the rinsate. Both groups treated with wash compositions including 500 ppm and 1000 ppm of ceragenin compound respectively, showed no detectable level of Salmonella bacteria. In other words, the wash composition including 500 ppm ceragenin compound killed 100% of Salmonella bacteria present. The wash composition including 1000 ppm ceragenin compound performed similarly.

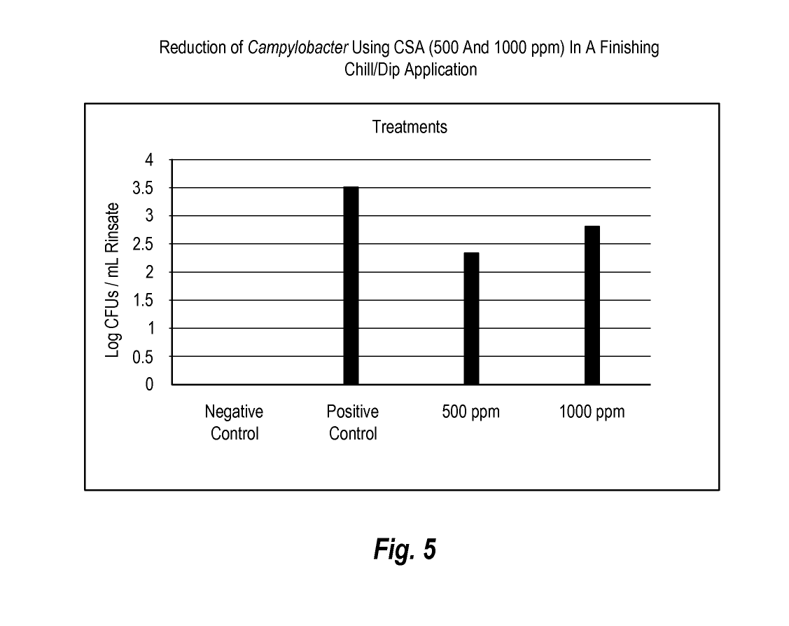

FIG. 5 shows the results for Campylobacter bacteria. The negative control showed no detectable Campylobacter bacteria. The positive control showed a level of 10^{3.5} CFUs/mL of Campylobacter in the rinsate. The group treated with a wash composition including 500 ppm of ceragenin compound showed a level of about 10^{2.3} CFUs/mL of Campylobacter in the rinsate, which represents a 1.2 log reduction. In other words, the treatment was effective in killing 93.7% of the Campylobacter bacteria. The group treated with a wash composition including 1000 ppm of ceragenin compound showed a level of about 10^{2.8} CFUs/mL of Campylobacter in the rinsate, which represents a 0.8 log reduction. In other words, the treatment was effective in killing 80% of the Campylobacter bacteria.

Campylobacter and Salmonella do not respond identically to different anti-microbials. Because the 1000 ppm treatment showed results that were no more effective on Campylobacter than the 500 ppm treatment, it is believed that a threshold may have been reached, so that no greater reductions in Campylobacter may be observed at CSA concentrations above about 500 ppm.

It is important to note that the inoculation level of Example 3 was significantly higher than would be naturally found or would be likely to occur as a result of a contamination event. As a result, it is likely that the wash compositions including 500 ppm to 1000 ppm ceragenin compound would eliminate essentially all Campylobacter and Salmonella present on a given food product. In addition, increasing the dip time to more than 30 seconds might likely result in greater kill rates for Campylobacter.

While existing chlorinated wash compositions can be effective in reducing the presence of Salmonella and Campylobacter bacteria when all requirements are met relative to pH management, organic matter content in the wash, and other factors, the use of such chlorinated wash compositions can lead to undesirable changes in the quality characteristics of the food product, while also being limited in ability to control pathogen bacterial outbreaks. Thus, the tested ceragenin containing wash compositions show equal or better effectiveness as compared to chlorinated wash compositions, without the potential for negative effects on quality characteristics, and potentially providing superior effectiveness with their ability to kill bacteria on such the surface of such food products.

### Example 4

Example 6 illustrates microbial colonization where a food product has been treated with ceragenin compounds at 7, 14, and 21 days. Food products were inoculated on day 1 with 10̂6 Salmonella and Campylobacter. The ceragenin compound was applied at day 10. Therefore, day 7 data does not reflect any ceragenin treatment. The results (colony forming units/sample) are illustrated in Table 2 below.

TABLE 2

| | 7 days | 14 days | 21 days |
|---|---|---|---|
| Water (control) | 4.40654018 | 2.73239376 | 3.991742785 |
| 50 ppm CSA | 5.166125505 | 3.736905626 | 2.835966777 |
| 100 ppm CSA | 4.474701781 | 3.18610838 | 2.672097858 |

There is a natural tendency for colonization to initially decrease over time, which is observed in the data in Table 2. However, as expected, by day 21 microbial colonization rebounded and continued to grow. In contrast, samples treated with 50 ppm and 100 ppm CSA continued declining through day 21. These results illustrate the desired resistance to colonization over time of food products treated according to the methods described herein.

### V. Additional Details of Ceragenin Compounds

In some embodiments disclosed herein the CSA compound may have a formula as set for in Formula (V):

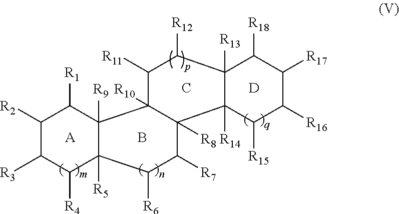

Where m, n, p, and q are independently 0 or 1; R¹-R¹⁸ represent substituents that are attached to the indicated atom on the steroid backbone (i.e., steroid group); and at least two, preferably at least three, of R¹-R¹⁸ each include a cationic group.

In one embodiment, rings A, B, C, and D are independently saturated, or are fully or partially unsaturated, provided that at least two of rings A, B, C, and D are saturated; m, n, p, and q are independently 0 or 1; R₁ through R₄, R₆, R₇, R₁₁, R₁₂, R₁₅, R₁₆, and R₁₈ are independently selected from the group consisting of hydrogen, hydroxyl, a substituted or unsubstituted alkyl, substituted or unsubstituted hydroxyalkyl, substituted or unsubstituted alkyloxyalkyl, substituted or unsubstituted alkylcarboxyalkyl, substituted or unsubstituted alkylaminoalkyl, substituted or unsubstituted alkylaminoalkylamino, substituted or unsubstituted alkylaminoalkylaminoalkylamino, a substituted or unsubstituted aminoalkyl, a substituted or unsubstituted aryl, a substituted or unsubstituted arylaminoalkyl, substituted or unsubstituted haloalkyl, substituted or unsubstituted alkenyl, substituted or unsubstituted alkynyl, oxo, a linking group attached to a second steroid, a substituted or unsubstituted aminoalkyloxy, a substituted or unsubstituted aminoalkyloxyalkyl, a substituted or unsubstituted aminoalkylcarboxy, a substituted or unsubstituted aminoalkylaminocarbonyl, a substituted or unsubstituted aminoalkylcarboxamido, a substituted or unsubstituted di(alkyl)aminoalkyl, a substituted or unsubstituted C-carboxyalkyl, H₂N—HC(Q₅)—C(O)—O—, H₂N—HC(Q₅)—C(O)—N(H)—, substituted or unsubstituted azidoalkyloxy, substituted or unsubstituted cyanoalkyloxy, P.G.-HN—HC(Q₅)—C(O)—O—, substituted or unsubstituted guanidinoalkyloxy, substituted or unsubstituted quaternaryammoniumalkylcarboxy, and substituted or unsubstituted guanidinoalkyl carboxy, where Q₅ is a side chain of any amino acid (including a side chain of glycine, i.e., H), and P.G. is an amino protecting group; and R₅, R₈, R₉, R₁₀, R₁₃, R₁₄ and R₁₇ are independently deleted when one of rings A, B, C, or D is unsaturated so as to complete the valency of the carbon atom at that site, or R₅, R₈, R₉, R₁₀, R₁₃, and R₁₄ are independently selected from the group consisting of hydrogen, hydroxyl, a substituted or unsubstituted alkyl, substituted or unsubstituted hydroxyalkyl, substituted or unsubstituted alkyloxyalkyl, a substituted or unsubstituted aminoalkyl, a substituted or unsubstituted aryl, substituted or unsubstituted haloalkyl, substituted or unsubstituted alkenyl, substituted or unsubstituted alkynyl, oxo, a linking group attached to a second steroid, a substituted or unsubstituted aminoalkyloxy, a substituted or unsubstituted aminoalkylcarboxy, a substituted or unsubstituted aminoalkylaminocarbonyl, a substituted or unsubstituted di(alkyl)aminoalkyl, a substituted or unsubstituted C-carboxyalkyl, H₂N—HC(Q₅)—C(O)—O—, H₂N—HC(Q₅)—C(O)—N(H)—, substituted or unsubstituted azidoalkyloxy, substituted or unsubstituted cyanoalkyloxy, P.G.-HN—HC(Q₅)—C(O)—O—, substituted or unsubstituted guanidinoalkyloxy, and substituted or unsubstituted guanidinoalkylcarboxy, where Q5 is a side chain of any amino acid, P.G. is an amino protecting group; provided that at least two or three of R₁₋₄, R₆, R₇, R₁₁, R₁₂, R₁₅, R₁₆, R₁₇, and R₁₈ are independently selected from the group consisting of a substituted or unsubstituted aminoalkyl, a substituted or unsubstituted aminoalkyloxy, substituted or unsubstituted alkylcarboxyalkyl, substituted or unsubstituted alkylaminoalkylamino, substituted or unsubstituted alkylaminoalkylaminoalkylamino, a substituted or unsubstituted aminoalkylcarboxy, a substituted or unsubstituted arylaminoalkyl, a substituted or unsubstituted aminoalkyloxyaminoalkylaminocarbonyl, a substituted or unsubstituted aminoalkylaminocarbonyl, a substituted or unsubstituted aminoalkylcarboxyamido, a substituted or unsubstituted quaternaryammoniumalkylcarboxy, a substituted or unsubstituted di(alkyl)aminoalkyl, a substituted or unsubstituted C-carboxyalkyl, H₂N—HC(Q₅)—C(O)—O—, H₂N—HC(Q₅)—C(O)—N(H)—, substituted or unsubstituted azidoalkyloxy, substituted or unsubstituted cyanoalkyloxy, P.G.-HN—HC(Q5)-C(O)—O—, substituted or unsubstituted guanidinoalkyloxy, and a substituted or unsubstituted guanidinoalkylcarboxy.

In some embodiments, R₁ through R₄, R₆, R₇, R₁₁, R₁₂, R₁₅, R₁₆, and R₁₈ are independently selected from the group consisting of hydrogen, hydroxyl, a substituted or unsubstituted (C₁-C₁₈) alkyl, substituted or unsubstituted (C₁-C₁₈) hydroxyalkyl, substituted or unsubstituted (C₁-C₁₈) alkyloxy-(C₁-C₁₈) alkyl, substituted or unsubstituted (C₁-C₁₈) alkylcarboxy-(C₁-C₁₈) alkyl, substituted or unsubstituted (C₁-C₁₈) alkylamino-(C₁-C₁₈)alkyl, substituted or unsubstituted (C₁-C₁₈) alkylamino-(C₁-C₁₈) alkylamino, substituted or unsubstituted (C₁-C₁₈) alkylamino-(C₁-C₁₈) alkylamino-(C₁-C₁₈) alkylamino, a substituted or unsubstituted (C₁-C₁₈) aminoalkyl, a substituted or unsubstituted aryl, a substituted or unsubstituted arylamino-(C₁-C₁₈) alkyl, substituted or unsubstituted (C₁-C₁₈) haloalkyl, substituted or unsubstituted (C₂-C₆) alkenyl, substituted or unsubstituted (C₂-C₆) alkynyl, oxo, a linking group attached to a second steroid, a substituted or unsubstituted (C₁-C₁₈) aminoalkyloxy, a substituted or unsubstituted (C₁-C₁₈) aminoalkyloxy-(C₁-C₁₈) alkyl, a substituted or unsubstituted (C₁-C₁₈) aminoalkylcarboxy, a substituted or unsubstituted (C₁-C₁₈) aminoalkylaminocarbonyl, a substituted or unsubstituted (C₁-C₁₈) aminoalkylcarboxamido, a substituted or unsubstituted di(C₁-C₁₈ alkyl)aminoalkyl, a substituted or unsubstituted C-carboxy(C₁-C₁₈)alkyl, H₂N—HC(Q₅)—C(O)—O—, H₂N—HC(Q₅)—C(O)—N(H)—, substituted or unsubstituted (C₁-C₁₈) azidoalkyloxy, substituted or unsubstituted (C₁-C₁₈) cyanoalkyloxy, P.G.-HN—HC(Q₅)—C(O)—O—, substituted or unsubstituted (C₁-C₁₈) guanidinoalkyloxy, substituted or unsubstituted (C₁-C₁₈) quaternaryammoniumalkylcarboxy, and substituted or unsubstituted (C₁-C₁₈) guanidinoalkyl carboxy, where Q₅ is a side chain of any amino acid (including a side chain of glycine, i.e., H), and P.G. is an amino protecting group; and R₅, R₈, R₉, R₁₀, R₁₃, R₁₄ and R₁₇ are independently deleted when one of rings A, B, C, or D is unsaturated so as to complete the valency of the carbon atom at that site, or R₅, R₈, R₉, R₁₀, R₁₃, and R₁₄ are independently selected from the group consisting of hydrogen, hydroxyl, a substituted or unsubstituted (C₁-C₁₈) alkyl, substituted or unsubstituted (C₁-C₁₈) hydroxyalkyl, substituted or unsubstituted (C₁-C₁₈) alkyloxy-(C₁-C₁₈) alkyl, a substituted or unsubstituted (C₁-C₁₈) aminoalkyl, a substituted or unsubstituted aryl, substituted or unsubstituted (C₁-C₁₈) haloalkyl, substituted or unsubstituted (C₂-C₆) alkenyl, substituted or unsubstituted (C₂-C₆) alkynyl, oxo, a linking group attached to a second steroid, a substituted or unsubstituted (C₁-C₁₈) aminoalkyloxy, a substituted or unsubstituted (C₁-C₁₈) aminoalkylcarboxy, a substituted or unsubstituted (C₁-C₁₈) aminoalkylaminocarbonyl, di(C₁-C₁₈ alkyl)aminoalkyl, a substituted or unsubstituted C-carboxy(C₁-C₁₈)alkyl, H₂N—HC(Q₅)—C(O)—O—, H₂N—HC(Q₅)—C(O)—N(H)—, substituted or unsubstituted (C₁-C₁₈) azidoalkyloxy, substituted or unsubstituted (C₁-C₁₈) cyanoalkyloxy, P.G.-HNHC(Q₅)—C(O)—O—, substituted or unsubstituted (C₁-C₁₈) guanidinoalkyloxy, and substituted or unsubstituted (C₁-C₁₈) guanidinoalkylcarboxy, where Q5 is a side chain of any amino acid, and P.G. is an amino protecting group; provided that at least two or three of R₁₋₄, R₆, R₇, R₁₁, R₁₂, R₁₅, R₁₆, R₁₇, and R₁₈ are independently selected from the group consisting of a substituted or unsubstituted (C₁-C₁₈) aminoalkyl, a substituted or unsubstituted (C₁-C₁₈) aminoalkyloxy, substituted or unsubstituted (C₁-C₁₈) alkylcarboxy-(C₁-C₁₈) alkyl, substituted or unsubstituted (C₁-C₁₈) alkylamino-(C₁-C₁₈) alkylamino, substituted or unsubstituted (C₁-C₁₈) alkylamino-(C₁-C₁₈) alkylamino (C₁-C₁₈) alkylamino, a substituted or unsubstituted (C₁-C₁₈) amino alkylcarboxy, a substituted or unsubstituted arylamino (C₁-C₁₈) alkyl, a substituted or unsubstituted (C₁-C₁₈) aminoalkyloxy (C₁-C₁₈) aminoalkylaminocarbonyl, a substituted or unsubstituted (C₁-C₁₈) aminoalkylaminocarbonyl, a substituted or unsubstituted (C₁-C₁₈) aminoalkylcarboxyamido, a substituted or unsubstituted (C₁-C₁₈) quaternaryammoniumalkylcarboxy, substituted or unsubstituted di (C₁-C₁₈ alkyl)amino alkyl, a substituted or unsubstituted C-carboxy(C₁-C₁₈)alkyl, H₂N—HC(Q₅)—C(O)—O—, H₂N—HC(Q₅)—C(O)—N(H)—, substituted or unsubstituted (C₁-C₁₈) azidoalkyloxy, substituted or unsubstituted (C₁-C₁₈) cyanoalkyloxy, P.G.-HN—HC(Q5)-—C(O)—O—, substituted or unsubstituted (C₁-C₁₈) guanidinoalkyloxy, and a substituted or unsubstituted (C₁-C₁₈) guanidinoalkylcarboxy.

In some embodiments, R₁ through R₄, R₆, R₇, R₁₁, R₁₂, R₁₅, R₁₆, and R₁₈ are independently selected from the group consisting of hydrogen, hydroxyl, an unsubstituted (C₁-C₁₈) alkyl, unsubstituted (C₁-C₁₈) hydroxyalkyl, unsubstituted (C₁-C₁₈) alkyloxy-(C₁-C₁₈) alkyl, unsubstituted (C₁-C₁₈) alkylcarboxy-(C₁-C₁₈) alkyl, unsubstituted (C₁-C₁₈) alkylamino-(C₁-C₁₈)alkyl, unsubstituted (C₁-C₁₈) alkylamino-(C₁-C₁₈) alkylamino, unsubstituted (C₁-C₁₈) alkylamino-(C₁-C₁₈) alkylamino-(C₁-C₁₈) alkylamino, an unsubstituted (C₁-C₁₈) aminoalkyl, an unsubstituted aryl, an unsubstituted arylamino-(C₁-C₁₈) alkyl, oxo, an unsubstituted (C₁-C₁₈) aminoalkyloxy, an unsubstituted (C₁-C₁₈) aminoalkyloxy-(C₁-C₁₈) alkyl, an unsubstituted (C₁-C₁₈) aminoalkylcarboxy, an unsubstituted (C₁-C₁₈) aminoalkylaminocarbonyl, an unsubstituted (C₁-C₁₈) aminoalkylcarboxamido, an unsubstituted di(C₁-C₁₈ alkyl)aminoalkyl, an unsubstituted C-carboxy(C₁-C₁₈)alkyl, unsubstituted (C₁-C₁₈) guanidinoalkyloxy, unsubstituted (C₁-C₁₈) quaternaryammoniumalkylcarboxy, and unsubstituted (C₁-C₁₈) guanidinoalkyl carboxy; and R₅, R₈, R₉, R₁₀, R₁₃, R₁₄ and R₁₇ are independently deleted when one of rings A, B, C, or D is unsaturated so as to complete the valency of the carbon atom at that site, or R₅, R₈, R₉, R₁₀, R₁₃, and R₁₄ are independently selected from the group consisting of hydrogen, hydroxyl, an unsubstituted (C₁-C₁₈) alkyl, unsubstituted (C₁-C₁₈) hydroxyalkyl, unsubstituted (C₁-C₁₈) alkyloxy-(C₁-C₁₈) alkyl, unsubstituted (C₁-C₁₈) alkylcarboxy-(C₁-C₁₈) alkyl, unsubstituted (C₁-C₁₈) alkylamino-(C₁-C₁₈)alkyl, unsubstituted (C₁-C₁₈) alkylamino-(C₁-C₁₈) alkylamino, unsubstituted (C₁-C₁₈) alkylamino-(C₁-C₁₈) alkylamino-(C₁-C₁₈) alkylamino, an unsubstituted (C₁-C₁₈) aminoalkyl, an unsubstituted aryl, an unsubstituted arylamino-(C₁-C₁₈) alkyl, oxo, an unsubstituted (C₁-C₁₈) aminoalkyloxy, an unsubstituted (C₁-C₁₈) aminoalkyloxy-(C₁-C₁₈) alkyl, an unsubstituted (C₁-C₁₈) aminoalkylcarboxy, an unsubstituted (C₁-C₁₈) aminoalkylaminocarbonyl, an unsubstituted (C₁-C₁₈) aminoalkylcarboxamido, an unsubstituted di(C₁-C₁₈ alkyl)aminoalkyl, an unsubstituted C-carboxy(C₁-C₁₈)alkyl, unsubstituted (C₁-C₁₈) guanidinoalkyloxy, unsubstituted (C₁-C₁₈) quaternaryammoniumalkylcarboxy, and unsubstituted (C₁-C₁₈) guanidinoalkyl carboxy; provided that at least two or three of R₁₋₄, R₆, R₇, R₁₁, R₁₂, R₁₅, R₁₆, R₁₇, and R₁₈ are independently selected from the group consisting of hydrogen, hydroxyl, an unsubstituted (C₁-C₁₈) alkyl, unsubstituted (C₁-C₁₈) hydroxyalkyl, unsubstituted (C₁-C₁₈) alkyloxy-(C₁-C₁₈) alkyl, unsubstituted (C₁-C₁₈) alkylcarboxy-(C₁-C₁₈) alkyl, unsubstituted (C₁-C₁₈) alkylamino-(C₁-C₁₈)alkyl, unsubstituted (C₁-C₁₈) alkylamino-(C₁-C₁₈) alkylamino, unsubstituted (C₁-C₁₈) alkylamino-(C₁-C₁₈) alkylamino-(C₁-C₁₈) alkylamino, an unsubstituted (C₁-C₁₈) aminoalkyl, an unsubstituted aryl, an unsubstituted arylamino-(C₁-C₁₈) alkyl, oxo, an unsubstituted (C₁-C₁₈) aminoalkyloxy, an unsubstituted (C₁-C₁₈) aminoalkyloxy-(C₁-C₁₈) alkyl, an unsubstituted (C₁-C₁₈) aminoalkylcarboxy, an unsubstituted (C₁-C₁₈) aminoalkylaminocarbonyl, an unsubstituted (C₁-C₁₈) aminoalkylcarboxamido, an unsubstituted di(C₁-C₁₈ alkyl)aminoalkyl, an unsubstituted C-carboxy(C₁-C₁₈)alkyl, unsubstituted (C₁-C₁₈) guanidinoalkyloxy, unsubstituted (C₁-C₁₈) quaternaryammoniumalkylcarboxy, and unsubstituted (C₁-C₁₈) guanidinoalkyl carboxy.

The ceragenin compounds used in the anti-microbial wash compositions described herein may also have a structure as shown in Formula I:

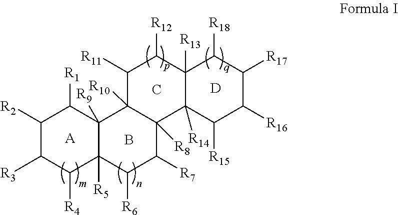

where each of fused rings A, B, C, and D is independently saturated, or is fully or partially unsaturated, provided that at least two of A, B, C, and D are saturated, wherein rings A, B, C, and D form a ring system; each of m, n, p, and q is independently 0 or 1 (i.e., each ring may independently be 5-membered or 6-membered); each of R₁ through R₄, R₆, R₇, R₁₁, R₁₂, R₁₅, R₁₆, R₁₇, and R₁₈ is independently selected from the group consisting of hydrogen, hydroxyl, a substituted or unsubstituted (C₁-C₁₀) alkyl, (C₁-C₁₀) hydroxyalkyl, (C₁-C₁₀) alkyloxy-(C₁-C₁₀) alkyl, (C₁-C₁₀) alkylcarboxy-(C₁-C₁₀) alkyl, (C₁-C₁₀) alkylamino-(C₁-C₁₀) alkyl, (C₁-C₁₀) alkylamino-(C₁-C₁₀) alkylamino, (C₁-C₁₀) alkylamino-(C₁-C₁₀) alkylamino-(C₁-C₁₀) alkylamino, a substituted or unsubstituted (C₁-C₁₀) aminoalkyl, a substituted or unsubstituted aryl, a substituted or unsubstituted arylamino-(C₁-C₁₀) alkyl, (C₁-C₁₀) haloalkyl, C₂-C₆ alkenyl, C₂-C₆ alkynyl, oxo, a linking group attached to a second steroid, a substituted or unsubstituted (C₁-C₁₀) aminoalkyloxy, a substituted or unsubstituted (C₁-C₁₀) aminoalkyloxy-(C₁-C₁₀) alkyl, a substituted or unsubstituted (C₁-C₁₀) aminoalkylcarboxy, a substituted or unsubstituted (C₁-C₁₀) aminoalkylaminocarbonyl, a substituted or unsubstituted (C₁-C₁₀) aminoalkylcarboxamido, H₂N—HC(Q₅)—C(O)—O—, H₂N—HC(Q₅)—C(O)—N(H)—, (C₁-C₁₀) azidoalkyloxy, (C₁-C₁₀) cyanoalkyloxy, P.G.-HN—HC(Q₅)—C(O)—O—, (C₁-C₁₀) guanidinoalkyloxy, (C₁-C₁₀) quaternaryammoniumalkylcarboxy, and (C₁-C₁₀) guanidinoalkyl carboxy, where Q₅ is a side chain of any amino acid (including a side chain of glycine, i.e., H), P.G. is an amino protecting group, and each of R₅, R₈, R₉, R₁₀, R₁₃, and R₁₄ may be independently deleted when one of fused rings A, B, C, or D is unsaturated so as to complete the valency of the carbon atom at that site, or selected from the group consisting of hydrogen, hydroxyl, a substituted or unsubstituted (C₁-C₁₀) alkyl, (C₁-C₁₀) hydroxyalkyl, (C₁-C₁₀) alkyloxy-(C₁-C₁₀) alkyl, a substituted or unsubstituted (C₁-C₁₀) aminoalkyl, a substituted or unsubstituted aryl, (C₁-C₁₀) haloalkyl, C₂-C₆ alkenyl, C₂-C₆ alkynyl, oxo, a linking group attached to a second steroid, a substituted or unsubstituted (C₁-C₁₀) aminoalkyloxy, a substituted or unsubstituted (C₁-C₁₀) aminoalkylcarboxy, a substituted or unsubstituted (C₁-C₁₀) aminoalkylaminocarbonyl, H₂NHC(Q₅)—C(O)—O—, H₂N—HC(Q₅)—C(O)—N(H)—, (C₁-C₁₀) azidoalkyloxy, (C₁-C₁₀) cyanoalkyloxy, P.G.-HN—HC(Q₅)—C(O)—O—, (C₁-C₁₀) guanidinoalkyloxy, and (C₁-C₁₀) guanidinoalkylcarboxy, where Q₅ is a side chain of any amino acid, P.G. is an amino protecting group, provided that at least two or three of R₁₋₄, R₆, R₇, R₁₁, R₁₂, R₁₅, R₁₆, R₁₇, and R₁₈ are independently selected from the group consisting of a substituted or unsubstituted (C₁-C₁₀) aminoalkyl, a substituted or unsubstituted (C₁-C₁₀) aminoalkyloxy, (C₁-C₁₀) alkylcarboxy-(C₁-C₁₀) alkyl, (C₁-C₁₀) alkylamino-(C₁-C₁₀) alkylamino, (C₁-C₁₀) alkylamino-(C₁-C₁₀) alkylamino-(C₁-C₁₀) alkylamino, a substituted or unsubstituted (C₁-C₁₀) aminoalkylcarboxy, a substituted or unsubstituted arylamino(C₁-C₁₀) alkyl, a substituted or unsubstituted (C₁-C₁₀) aminoalkyloxy-(C₁-C₁₀) aminoalkylaminocarbonyl, a substituted or unsubstituted (C₁-C₁₀) aminoalkylaminocarbonyl, a substituted or unsubstituted (C₁-C₅) aminoalkylcarboxyamido, a (C₁-C₁₀) quaternaryammonium alkylcarboxy, H₂N—HC(Q₅)—C(O)—O—, H₂N—HC(Q₅)—C(O)—N(H)—, (C₁-C₁₀) azidoalkyloxy, (C₁-C₁₀) cyanoalkyloxy, P.G.-HN—HC(Q₅)—C(O)—O—, (C₁-C₁₀) guanidinoalkyloxy, and a (C₁-C₁₀) guanidinoalkylcarboxy.

In Formula I, at least two or at least three of R₃, R₇, or R₁₂ may independently include a cationic moiety attached to the Formula I structure via a non-hydrolysable or hydrolysable linkage. Optionally, a tail moiety may be attached to Formula I at R₁₇. The tail moiety may be charged, uncharged, polar, non-polar, hydrophobic, amphipathic, and the like. Although not required, at least two or three of m, n, p. and q may be 1. In a preferred embodiment, m, n, and p=1 and q=0. Examples of such structures are shown in FIGS. 1A-1B.

In some embodiments, the ceragenin compounds of Formula (I), can be also represented by Formula (II):

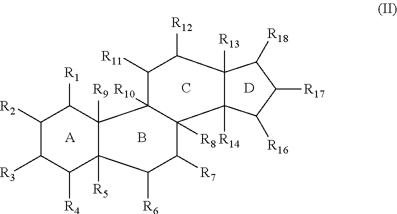

In some embodiments, rings A, B, C, and D are independently saturated.

In some embodiments, one or more of rings A, B, C, and D are heterocyclic.

In some embodiments, rings A, B, C, and D are non-heterocyclic.

In some embodiments, R₃, R₇, R₁₂, and R₁₈ are independently selected from the group consisting of hydrogen, an unsubstituted (C₁-C₁₈) alkyl, unsubstituted (C₁-C₁₈) hydroxyalkyl, unsubstituted (C₁-C₁₈) alkyloxy-(C₁-C₁₈) alkyl, unsubstituted (C₁-C₁₈) alkylcarboxy-(C₁-C₁₈) alkyl, unsubstituted (C₁-C₁₈) alkylamino-(C₁-C₁₈)alkyl, unsubstituted (C₁-C₁₈) alkylamino-(C₁-C₁₈) alkylamino, unsubstituted (C₁-C₁₈) alkylamino-(C₁-C₁₈) alkylamino-(C₁-C₁₈) alkylamino, an unsubstituted (C₁-C₁₈) aminoalkyl, an unsubstituted arylamino-(C₁-C₁₈) alkyl, an unsubstituted (C₁-C₁₈) aminoalkyloxy, an unsubstituted (C₁-C₁₈) aminoalkyloxy-(C₁-C₁₈) alkyl, an unsubstituted (C₁-C₁₈) aminoalkylcarboxy, an unsubstituted (C₁-C₁₈) aminoalkylaminocarbonyl, an unsubstituted (C₁-C₁₈) aminoalkylcarboxamido, an unsubstituted di(C₁-C₁₈ alkyl)aminoalkyl, unsubstituted (C₁-C₁₈) guanidinoalkyloxy, unsubstituted (C₁-C₁₈) quaternaryammoniumalkylcarboxy, and unsubstituted (C₁-C₁₈) guanidinoalkyl carboxy; and R₁, R₂, R₄, R₅, R₆, R₈, R₉, R₁₀, R₁₁, R₁₃, R₁₄, R₁₅, R₁₆, and R₁₇ are independently selected from the group consisting of hydrogen and unsubstituted (C₁-C₆) alkyl.

In some embodiments, R₃, R₇, R₁₂, and R₁₈ are independently selected from the group consisting of hydrogen, an unsubstituted (C₁-C₆) alkyl, unsubstituted (C₁-C₆) hydroxyalkyl, unsubstituted (C₁-C₁₆) alkyloxy-(C₁-C₅) alkyl, unsubstituted (C₁-C₁₆) alkylcarboxy-(C₁-C₅) alkyl, unsubstituted (C₁-C₁₆) alkylamino-(C₁-C₅)alkyl, unsubstituted (C₁-C₁₆) alkylamino-(C₁-C₅) alkylamino, unsubstituted (C₁-C₁₆) alkylamino-(C₁-C₁₆) alkylamino-(C₁-C₅) alkylamino, an unsubstituted (C₁-C₁₆) aminoalkyl, an unsubstituted arylamino-(C₁-C₅) alkyl, an unsubstituted (C₁-C₅) aminoalkyloxy, an unsubstituted (C₁-C₁₆) aminoalkyloxy-(C₁-C₅) alkyl, an unsubstituted (C₁-C₅) aminoalkylcarboxy, an unsubstituted (C₁-C₅) aminoalkylaminocarbonyl, an unsubstituted (C₁-C₅) aminoalkylcarboxamido, an unsubstituted di(C₁-C₅ alkyl)amino-(C₁-C₅) alkyl, unsubstituted (C₁-C₅) guanidinoalkyloxy, unsubstituted (C₁-C₁₆) quaternaryammoniumalkylcarboxy, and unsubstituted (C₁-C₁₆) guanidinoalkylcarboxy;

In some embodiments, R₁, R₂, R₄, R₅, R₆, R₈, R₁₀, R₁₁, R₁₄, R₁₆, and R₁₇ are each hydrogen; and R₉ and R₁₃ are each methyl.

In some embodiments, R₃, R₇, R₁₂, and R₁₈ are independently selected from the group consisting of aminoalkyloxy; aminoalkylcarboxy; alkylaminoalkyl; alkoxycarbonylalkyl; alkylcarbonylalkyl; di(alkyl)aminoalkyl; alkoxycarbonylalkyl; and alkylcarboxyalkyl.

In some embodiments, R₃, R₇, and R₁₂ are independently selected from the group consisting of aminoalkyloxy and aminoalkylcarboxy; and R₁₈ is selected from the group consisting of alkylaminoalkyl; alkoxycarbonylalkyl; alkylcarbonyloxyalkyl; di(alkyl)aminoalkyl; alkylaminoalkyl; alkoxycarbonylalkyl; and alkylcarboxyalkyl.

In some embodiments, R₃, R₇, and R₁₂ are the same.

In some embodiments, R₃, R₇, and R₁₂ are aminoalkyloxy.

In some embodiments, R₃, R₇, and R₁₂ are aminoalkylcarboxy.

In some embodiments, R₁₈ is alkylaminoalkyl.

In some embodiments, R₁₈ is alkoxycarbonylalkyl.

In some embodiments, R₁₈ is di(alkyl)aminoalkyl.

In some embodiments, R₁₈ is alkylcarboxyalkyl.

In some embodiments, R₃, R₇, R₁₂, and R₁₈ are independently selected from the group consisting of amino-C₃-alkyloxy; amino-C₃-alkyl-carboxy; C₈-alkylamino-C₅-alkyl; C₈-alkoxy-carbonyl-C₄-alkyl; C₈-alkyl-carbonyl-C₄-alkyl; di-(C₅-alkyl)amino-C₅-alkyl; C₁₃-alkylamino-C₅-alkyl; C₆-alkoxy-carbonyl-C₄-alkyl; C₆-alkyl-carboxy-C₄-alkyl; and C₁₆-alkylamino-C₅-alkyl.

In some embodiments, m, n, and p are each 1 and q is 0.

In some embodiments, the ceragenin compounds of Formula (I) can be also represented by Formula (III):

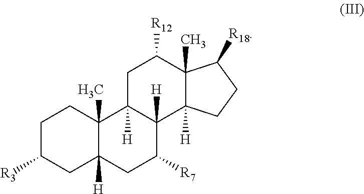

In some embodiments, the CSA, or a pharmaceutically acceptable salt thereof, is:

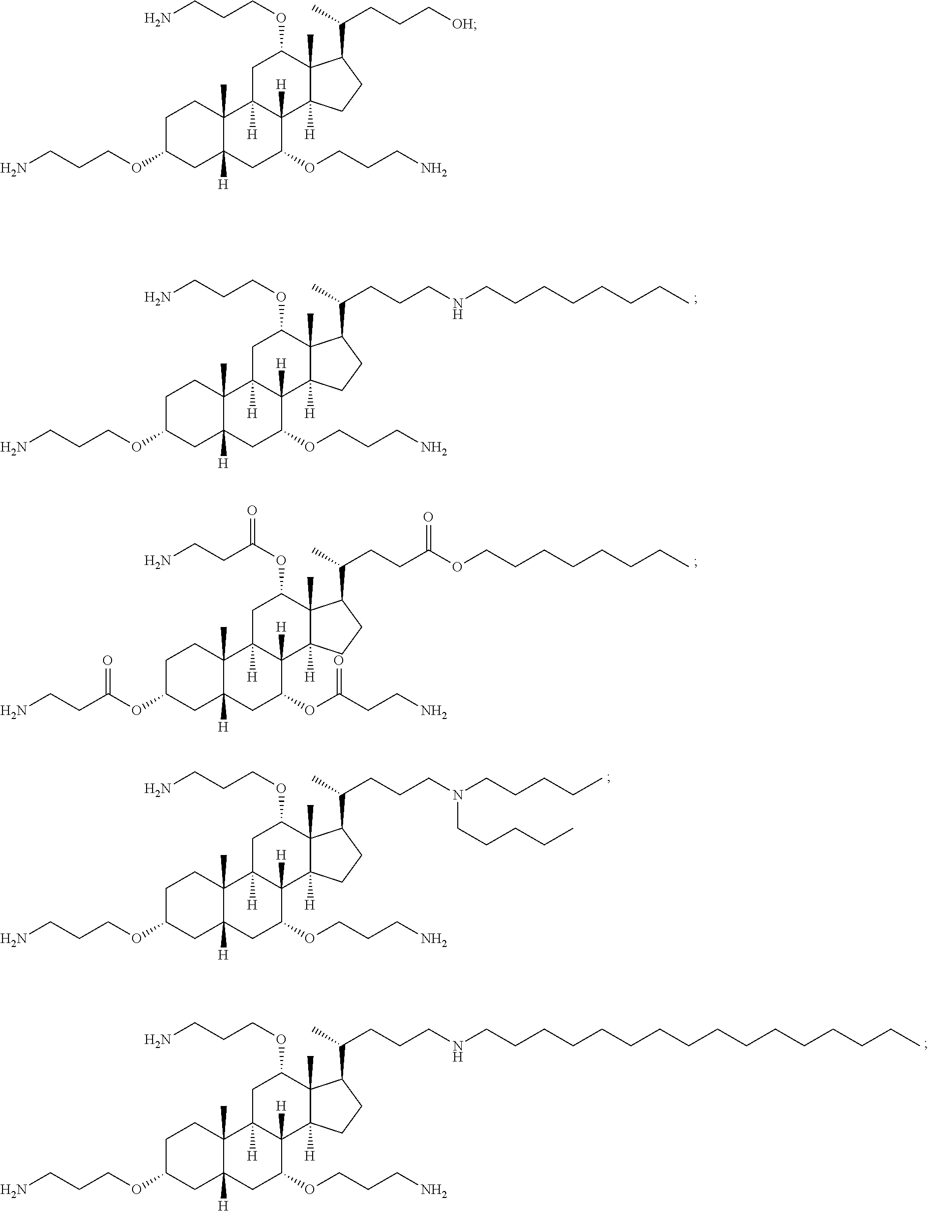

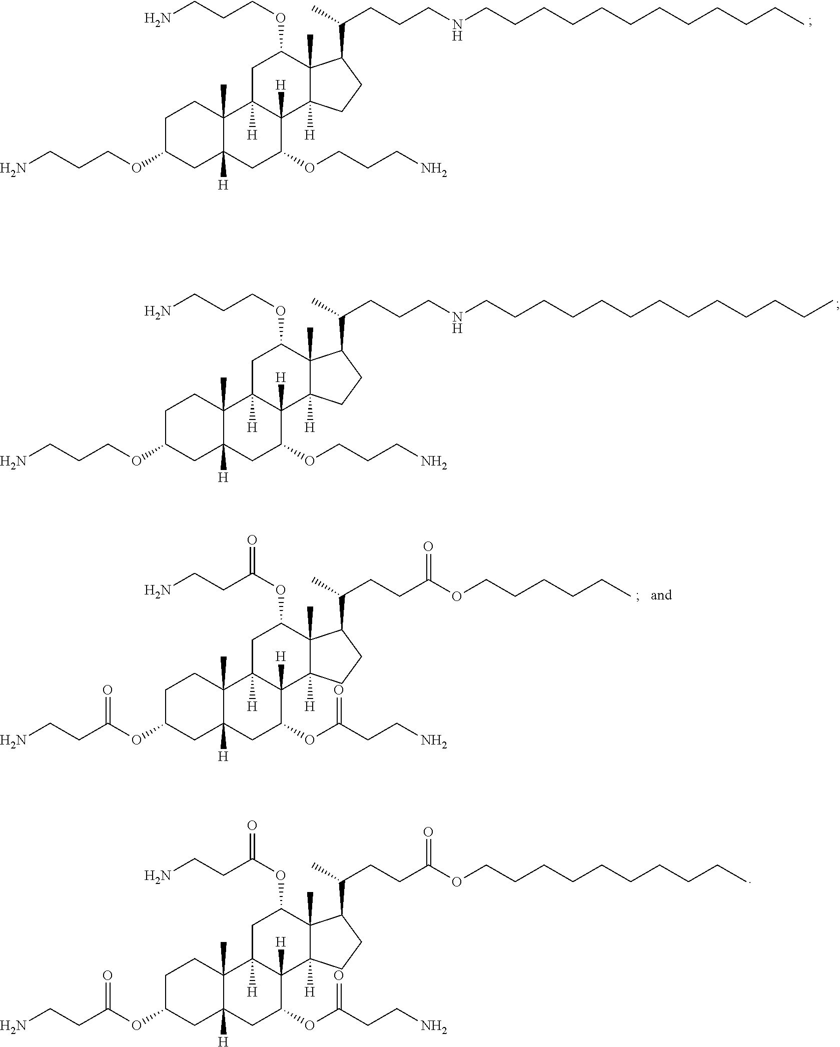

In some embodiments, the ceragenin compound is

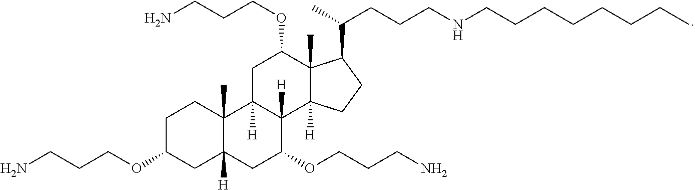

In other embodiments, the ceragenin compound is

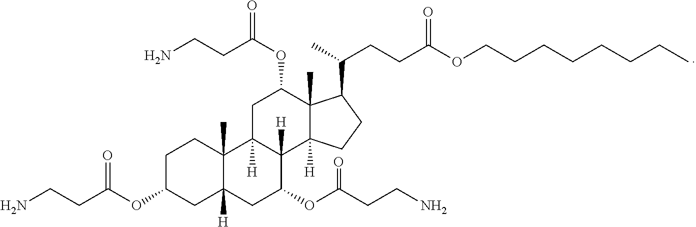

In other embodiments, the ceragenin compound is

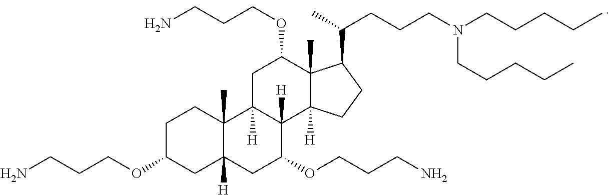

In other embodiments, the ceragenin compound is

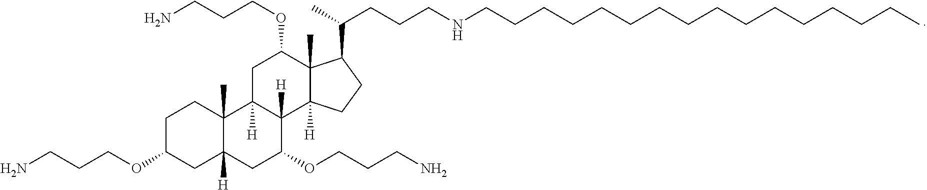

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment. In addition, the term “comprising” is to be interpreted synonymously with the phrases “having at least” or “including at least”. When used in the context of a process, the term “comprising” means that the process includes at least the recited steps, but may include additional steps. When used in the context of a compound, composition or device, the term “comprising” means that the compound, composition or device includes at least the recited features or components, but may also include additional features or components. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure, enantiomerically enriched, racemic mixture, diastereomerically pure, diastereomerically enriched, or a stereoisomeric mixture. In addition it is understood that, in any compound described herein having one or more double bond(s) generating geometrical isomers that can be defined as E or Z, each double bond may independently be E or Z a mixture thereof.

Likewise, it is understood that, in any compound described, all tautomeric forms are also intended to be included.

It is to be understood that where compounds disclosed herein have unfilled valencies, then the valencies are to be filled with hydrogens or isotopes thereof, e.g., hydrogen-1 (protium) and hydrogen-2 (deuterium).

It is understood that the compounds described herein can be labeled isotopically. Substitution with isotopes such as deuterium may afford certain therapeutic advantages resulting from greater metabolic stability, such as, for example, increased in vivo half-life or reduced dosage requirements. Each chemical element as represented in a compound structure may include any isotope of said element. For example, in a compound structure a hydrogen atom may be explicitly disclosed or understood to be present in the compound. At any position of the compound that a hydrogen atom may be present, the hydrogen atom can be any isotope of hydrogen, including but not limited to hydrogen-1 (protium) and hydrogen-2 (deuterium). Thus, reference herein to a compound encompasses all potential isotopic forms unless the context clearly dictates otherwise.

It is understood that the methods and combinations described herein include crystalline forms (also known as polymorphs, which include the different crystal packing arrangements of the same elemental composition of a compound), amorphous phases, salts, solvates, and hydrates. In some embodiments, the compounds described herein exist in solvated forms with pharmaceutically acceptable solvents such as water, ethanol, or the like. In other embodiments, the compounds described herein exist in unsolvated form. Solvates contain either stoichiometric or non-stoichiometric amounts of a solvent, and may be formed during the process of crystallization with pharmaceutically acceptable solvents such as water, ethanol, or the like. Hydrates are formed when the solvent is water, or alcoholates are formed when the solvent is alcohol. In addition, the compounds provided herein can exist in unsolvated as well as solvated forms. In general, the solvated forms are considered equivalent to the unsolvated forms for the purposes of the compounds and methods provided herein.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present embodiments. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein. Where a range of values is provided, it is understood that the upper and lower limit, and each intervening value between the upper and lower limit of the range is encompassed within the embodiments.

As used herein, any “R” group(s) such as, without limitation, R¹, R², R³, R⁴, R⁵, R⁶, R⁷, R⁸, R⁹, R¹⁰, R¹¹, R¹², R¹³, R¹⁴, R¹⁵, R¹⁶, R¹⁷, and R¹⁸ represent substituents that can be attached to the indicated atom. Unless otherwise specified, an R group may be substituted or unsubstituted.

The term “ring” as used herein can be heterocyclic or carbocyclic. The term “saturated” as used herein refers to the fused ring of Formula I having each atom in the fused ring either hydrogenated or substituted such that the valency of each atom is filled. The term “unsaturated” as used herein refers to the fused ring of Formula I where the valency of each atom of the fused ring may not be filled with hydrogen or other substituent groups. For example, adjacent carbon atoms in the fused ring can be doubly bound to each other. Unsaturation can also include deleting at least one of the following pairs and completing the valency of the ring carbon atoms at these deleted positions with a double bond; such as R₅ and R₉; R₈ and R₁₀; and R₁₃ and R₁₄.

Whenever a group is described as being “substituted” that group may be substituted with one, two, three or more of the indicated substituents, which may be the same or different, each replacing a hydrogen atom. If no substituents are indicated, it is meant that the indicated “substituted” group may be substituted with one or more group(s) individually and independently selected from alkyl, alkenyl, alkynyl, cycloalkyl, cycloalkenyl, cycloalkynyl, acylalkyl, alkoxyalkyl, aminoalkyl, amino acid, aryl, heteroaryl, heteroalicyclyl, aralkyl, heteroaralkyl, (heteroalicyclyl)alkyl, hydroxy, protected hydroxyl, alkoxy, aryloxy, acyl, mercapto, alkylthio, arylthio, cyano, halogen (e.g., F, Cl, Br, and I), thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, oxo, silyl, sulfenyl, sulfinyl, sulfonyl, haloalkyl, haloalkoxy, trihalomethanesulfonyl, trihalomethanesulfonamido, an amino, a mono-substituted amino group and a di-substituted amino group, R^{a}O(CH₂)ₘO—, R^{b}(CH₂)ₙO—, R^{c}C(O)O(CH₂)ₚO—, and protected derivatives thereof. The substituent may be attached to the group at more than one attachment point. For example, an aryl group may be substituted with a heteroaryl group at two attachment points to form a fused multicyclic aromatic ring system. Biphenyl and naphthalene are two examples of an aryl group that is substituted with a second aryl group.

As used herein, “Cₐ” or “Cₐ to C_{b}” in which “a” and “b” are integers refer to the number of carbon atoms in an alkyl, alkenyl or alkynyl group, or the number of carbon atoms in the ring of a cycloalkyl, cycloalkenyl, cycloalkynyl, aryl, heteroaryl or heteroalicyclyl group. That is, the alkyl, alkenyl, alkynyl, ring of the cycloalkyl, ring of the cycloalkenyl, ring of the cycloalkynyl, ring of the aryl, ring of the heteroaryl or ring of the heteroalicyclyl can contain from “a” to “b”, inclusive, carbon atoms. Thus, for example, a “C₁ to C₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—. If no “a” and “b” are designated with regard to an alkyl, alkenyl, alkynyl, cycloalkyl cycloalkenyl, cycloalkynyl, aryl, heteroaryl or heteroalicyclyl group, the broadest range described in these definitions is to be assumed.

As used herein, “alkyl” refers to a straight or branched hydrocarbon chain that comprises a fully saturated (no double or triple bonds) hydrocarbon group. The alkyl group may have 1 to 25 carbon atoms (whenever it appears herein, a numerical range such as “1 to 25” refers to each integer in the given range; e.g., “1 to 25 carbon atoms” means that the alkyl group may consist of 1 carbon atom, 2 carbon atoms, 3 carbon atoms, etc., up to and including 25 carbon atoms, although the present definition also covers the occurrence of the term “alkyl” where no numerical range is designated). The alkyl group may also be a medium size alkyl having 1 to 15 carbon atoms. The alkyl group could also be a lower alkyl having 1 to 6 carbon atoms. The alkyl group of the compounds may be designated as “C₄” or “C₁-C₄ alkyl” or similar designations. By way of example only, “C₁-C₄ alkyl” indicates that there are one to four carbon atoms in the alkyl chain, i.e., the alkyl chain is selected from methyl, ethyl, propyl, iso-propyl, n-butyl, iso-butyl, sec-butyl, and t-butyl. Typical alkyl groups include, but are in no way limited to, methyl, ethyl, propyl, isopropyl, butyl, isobutyl, tertiary butyl, pentyl and hexyl. The alkyl group may be substituted or unsubstituted.

As used herein, “alkenyl” refers to an alkyl group that contains in the straight or branched hydrocarbon chain one or more double bonds. The alkenyl group may have 2 to 25 carbon atoms (whenever it appears herein, a numerical range such as “2 to 25” refers to each integer in the given range; e.g., “2 to 25 carbon atoms” means that the alkenyl group may consist of 2 carbon atom, 3 carbon atoms, 4 carbon atoms, etc., up to and including 25 carbon atoms, although the present definition also covers the occurrence of the term “alkenyl” where no numerical range is designated). The alkenyl group may also be a medium size alkenyl having 2 to 15 carbon atoms. The alkenyl group could also be a lower alkenyl having 1 to 6 carbon atoms. The alkenyl group of the compounds may be designated as “C₄” or “C₂-C₄ alkyl” or similar designations. An alkenyl group may be unsubstituted or substituted.

As used herein, “alkynyl” refers to an alkyl group that contains in the straight or branched hydrocarbon chain one or more triple bonds. The alkynyl group may have 2 to 25 carbon atoms (whenever it appears herein, a numerical range such as “2 to 25” refers to each integer in the given range; e.g., “2 to 25 carbon atoms” means that the alkynyl group may consist of 2 carbon atom, 3 carbon atoms, 4 carbon atoms, etc., up to and including 25 carbon atoms, although the present definition also covers the occurrence of the term “alkynyl” where no numerical range is designated). The alkynyl group may also be a medium size alkynyl having 2 to 15 carbon atoms. The alkynyl group could also be a lower alkynyl having 2 to 6 carbon atoms. The alkynyl group of the compounds may be designated as “C₄” or “C₂-C₄ alkyl” or similar designations. An alkynyl group may be unsubstituted or substituted.

As used herein, “aryl” refers to a carbocyclic (all carbon) monocyclic or multicyclic aromatic ring system (including fused ring systems where two carbocyclic rings share a chemical bond) that has a fully delocalized pi-electron system throughout all the rings. The number of carbon atoms in an aryl group can vary. For example, the aryl group can be a C₆-C₁₄ aryl group, a C₆-C₁₀ aryl group, or a C₆ aryl group (although the definition of C₆-C₁₀ aryl covers the occurrence of “aryl” when no numerical range is designated). Examples of aryl groups include, but are not limited to, benzene, naphthalene and azulene. An aryl group may be substituted or unsubstituted.

As used herein, “aralkyl” and “aryl(alkyl)” refer to an aryl group connected, as a substituent, via a lower alkylene group. The aralkyl group may have 6 to 20 carbon atoms (whenever it appears herein, a numerical range such as “6 to 20” refers to each integer in the given range; e.g., “6 to 20 carbon atoms” means that the aralkyl group may consist of 6 carbon atom, 7 carbon atoms, 8 carbon atoms, etc., up to and including 20 carbon atoms, although the present definition also covers the occurrence of the term “aralkyl” where no numerical range is designated). The lower alkylene and aryl group of an aralkyl may be substituted or unsubstituted. Examples include but are not limited to benzyl, 2-phenylalkyl, 3-phenylalkyl, and naphthylalkyl.

“Lower alkylene groups” refer to a C₁-C₂₅ straight-chained alkyl tethering groups, such as —CH₂— tethering groups, forming bonds to connect molecular fragments via their terminal carbon atoms. Examples include but are not limited to methylene (—CH₂—), ethylene (—CH₂CH₂—), propylene (—CH₂CH₂CH₂—), and butylene (—CH₂CH₂CH₂CH₂—). A lower alkylene group can be substituted by replacing one or more hydrogen of the lower alkylene group with a substituent(s) listed under the definition of “substituted.”

As used herein, “cycloalkyl” refers to a completely saturated (no double or triple bonds) mono- or multi-cyclic hydrocarbon ring system. When composed of two or more rings, the rings may be joined together in a fused fashion. Cycloalkyl groups can contain 3 to 10 atoms in the ring(s) or 3 to 8 atoms in the ring(s). A cycloalkyl group may be unsubstituted or substituted. Typical cycloalkyl groups include, but are in no way limited to, cyclopropyl, cyclobutyl, cyclopentyl, cyclohexyl, cycloheptyl and cyclooctyl.

As used herein, “cycloalkenyl” refers to a mono- or multi-cyclic hydrocarbon ring system that contains one or more double bonds in at least one ring; although, if there is more than one, the double bonds cannot form a fully delocalized pi-electron system throughout all the rings (otherwise the group would be “aryl,” as defined herein). When composed of two or more rings, the rings may be connected together in a fused fashion. A cycloalkenyl group may be unsubstituted or substituted.

As used herein, “cycloalkynyl” refers to a mono- or multi-cyclic hydrocarbon ring system that contains one or more triple bonds in at least one ring. If there is more than one triple bond, the triple bonds cannot form a fully delocalized pi-electron system throughout all the rings. When composed of two or more rings, the rings may be joined together in a fused fashion. A cycloalkynyl group may be unsubstituted or substituted.

As used herein, “alkoxy” or “alkyloxy” refers to the formula OR wherein R is an alkyl, an alkenyl, an alkynyl, a cycloalkyl, a cycloalkenyl or a cycloalkynyl as defined above. A non-limiting list of alkoxys are methoxy, ethoxy, n-propoxy, 1-methylethoxy (isopropoxy), n-butoxy, iso-butoxy, sec-butoxy and tert-butoxy. An alkoxy may be substituted or unsubstituted.

As used herein, “acyl” refers to a hydrogen, alkyl, alkenyl, alkynyl, aryl, or heteroaryl connected, as substituents, via a carbonyl group. Examples include formyl, acetyl, propanoyl, benzoyl, and acryl. An acyl may be substituted or unsubstituted.

As used herein, “alkoxyalkyl” or “alkyloxyalkyl” refers to an alkoxy group connected, as a substituent, via a lower alkylene group. Examples include alkyl-O-alkyl- and alkoxy-alkyl-with the terms alkyl and alkoxy defined herein.

As used herein, “hydroxyalkyl” refers to an alkyl group in which one or more of the hydrogen atoms are replaced by a hydroxy group. Exemplary hydroxyalkyl groups include but are not limited to, 2-hydroxyethyl, 3-hydroxypropyl, 2-hydroxypropyl, and 2,2-dihydroxyethyl. A hydroxyalkyl may be substituted or unsubstituted.

As used herein, “haloalkyl” refers to an alkyl group in which one or more of the hydrogen atoms are replaced by a halogen (e.g., mono-haloalkyl, di-haloalkyl and tri-haloalkyl). Such groups include but are not limited to, chloromethyl, fluoromethyl, difluoromethyl, trifluoromethyl and 1-chloro-2-fluoromethyl, 2-fluoroisobutyl. A haloalkyl may be substituted or unsubstituted.

The term “amino” as used herein refers to a —NH₂ group.

As used herein, the term “hydroxy” refers to a —OH group.

A “cyano” group refers to a “—CN” group.

A “carbonyl” or an “oxo” group refers to a C═O group.

The term “azido” as used herein refers to a —N₃ group.

As used herein, “aminoalkyl” refers to an amino group connected, as a substituent, via a lower alkylene group. Examples include H₂N-alkyl-with the term alkyl defined herein.

As used herein, “alkylcarboxyalkyl” refers to an alkyl group connected, as a substituent, to a carboxy group that is connected, as a substituent, to an alkyl group. Examples include alkyl-C(═O)O-alkyl- and alkyl-O—C(═O)-alkyl- with the term alkyl as defined herein.

As used herein, “alkylaminoalkyl” refers to an alkyl group connected, as a substituent, to an amino group that is connected, as a substituent, to an alkyl group. Examples include alkyl-NH-alkyl-, with the term alkyl as defined herein.

As used herein, “dialkylaminoalkyl” or “di(alkyl)aminoalkyl” refers to two alkyl groups connected, each as a substituent, to an amino group that is connected, as a substituent, to an alkyl group. Examples include

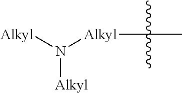

with the term alkyl as defined herein.

As used herein, “alkylaminoalkylamino” refers to an alkyl group connected, as a substituent, to an amino group that is connected, as a substituent, to an alkyl group that is connected, as a substituent, to an amino group. Examples include alkyl-NH-alkyl-NH—, with the term alkyl as defined herein.

As used herein, “alkylaminoalkylaminoalkylamino” refers to an alkyl group connected, as a substituent, to an amino group that is connected, as a substituent, to an alkyl group that is connected, as a substituent, to an amino group that is connected, as a substituent, to an alkyl group. Examples include alkyl-NH-alkyl-NH-alkyl-, with the term alkyl as defined herein.

As used herein, “arylaminoalkyl” refers to an aryl group connected, as a substituent, to an amino group that is connected, as a substituent, to an alkyl group. Examples include aryl-NH-alkyl-, with the terms aryl and alkyl as defined herein.

As used herein, “aminoalkyloxy” refers to an amino group connected, as a substituent, to an alkyloxy group. Examples include H₂N-alkyl-O— and H₂N-alkoxy- with the terms alkyl and alkoxy as defined herein.

As used herein, “aminoalkyloxyalkyl” refers to an amino group connected, as a substituent, to an alkyloxy group connected, as a substituent, to an alkyl group. Examples include H₂N-alkyl-O-alkyl- and H₂N-alkoxy-alkyl- with the terms alkyl and alkoxy as defined herein.

As used herein, “aminoalkylcarboxy” refers to an amino group connected, as a substituent, to an alkyl group connected, as a substituent, to a carboxy group. Examples include H₂N-alkyl-C(═O)O— and H₂N-alkyl-O—C(═O)— with the term alkyl as defined herein.

As used herein, “aminoalkylaminocarbonyl” refers to an amino group connected, as a substituent, to an alkyl group connected, as a substituent, to an amino group connected, as a substituent, to a carbonyl group. Examples include H₂N-alkyl-NH—C(═O)— with the term alkyl as defined herein.

As used herein, “aminoalkylcarboxamido” refers to an amino group connected, as a substituent, to an alkyl group connected, as a substituent, to a carbonyl group connected, as a substituent to an amino group. Examples include H₂N-alkyl-C(═O)—NH— with the term alkyl as defined herein.

As used herein, “azidoalkyloxy” refers to an azido group connected as a substituent, to an alkyloxy group. Examples include N₃-alkyl-O— and N₃-alkoxy- with the terms alkyl and alkoxy as defined herein.

As used herein, “cyanoalkyloxy” refers to a cyano group connected as a substituent, to an alkyloxy group. Examples include NC-alkyl-O— and NC-alkoxy- with the terms alkyl and alkoxy as defined herein.

As used herein, “guanidinoalkyloxy” refers to a guanidinyl group connected, as a substituent, to an alkyloxy group. Examples include

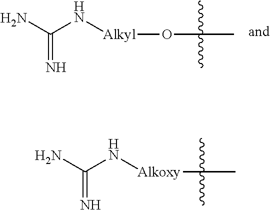

with the terms alkyl and alkoxy as defined herein.

As used herein, “guanidinoalkylcarboxy” refers to a guanidinyl group connected, as a substituent, to an alkyl group connected, as a substituent, to a carboxy group. Examples include

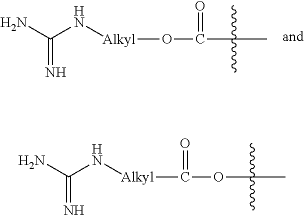

with the term alkyl as defined herein.

As used herein, “quaternaryammoniumalkylcarboxy” refers to a quaternized amino group connected, as a substituent, to an alkyl group connected, as a substituent, to a carboxy group. Examples include

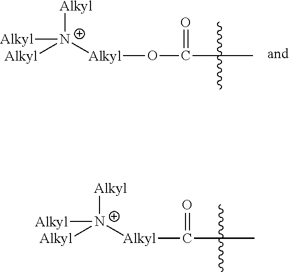

with the term alkyl as defined herein.

The term “halogen atom” or “halogen” as used herein, means any one of the radio-stable atoms of column 7 of the Periodic Table of the Elements, such as, fluorine, chlorine, bromine and iodine.

Where the numbers of substituents is not specified (e.g. haloalkyl), there may be one or more substituents present. For example “haloalkyl” may include one or more of the same or different halogens.

As used herein, the term “amino acid” refers to any amino acid (both standard and non-standard amino acids), including, but not limited to, α-amino acids, β-amino acids, γ-amino acids and δ-amino acids. Examples of suitable amino acids include, but are not limited to, alanine, asparagine, aspartate, cysteine, glutamate, glutamine, glycine, proline, serine, tyrosine, arginine, histidine, isoleucine, leucine, lysine, methionine, phenylalanine, threonine, tryptophan and valine. Additional examples of suitable amino acids include, but are not limited to, ornithine, hypusine, 2-aminoisobutyric acid, dehydroalanine, gamma-aminobutyric acid, citrulline, beta-alanine, alpha-ethyl-glycine, alpha-propyl-glycine and norleucine.

A linking group is a divalent moiety used to link one steroid to another steroid. In some embodiments, the linking group is used to link a first CSA with a second CSA (which may be the same or different). An example of a linking group is (C₁-C₁₀) alkyloxy-(C₁-C₁₀) alkyl.

The terms as used “P.G.” or “protecting group” or “protecting groups” herein refer to any atom or group of atoms that is added to a molecule in order to prevent existing groups in the molecule from undergoing unwanted chemical reactions. Examples of protecting group moieties are described in T. W. Greene and P. G. M. Wuts, Protective Groups in Organic Synthesis, 3. Ed. John Wiley & Sons, 1999, and in J. F. W. McOmie, Protective Groups in Organic Chemistry Plenum Press, 1973, both of which are hereby incorporated by reference for the limited purpose of disclosing suitable protecting groups. The protecting group moiety may be chosen in such a way, that they are stable to certain reaction conditions and readily removed at a convenient stage using methodology known from the art. A non-limiting list of protecting groups include benzyl; substituted benzyl; alkylcarbonyls and alkoxycarbonyls (e.g., t-butoxycarbonyl (BOC), acetyl, or isobutyryl); arylalkylcarbonyls and arylalkoxycarbonyls (e.g., benzyloxycarbonyl); substituted methyl ether (e.g. methoxymethyl ether); substituted ethyl ether; a substituted benzyl ether; tetrahydropyranyl ether; silyls (e.g., trimethylsilyl, triethylsilyl, triisopropylsilyl, t-butyldimethylsilyl, tri-iso-propylsilyloxymethyl, [2-(trimethylsilyl)ethoxy]methyl or t-butyldiphenylsilyl); esters (e.g. benzoate ester); carbonates (e.g. methoxymethylcarbonate); sulfonates (e.g. tosylate or mesylate); acyclic ketal (e.g. dimethyl acetal); cyclic ketals (e.g., 1,3-dioxane, 1,3-dioxolanes, and those described herein); acyclic acetal; cyclic acetal (e.g., those described herein); acyclic hemiacetal; cyclic hemiacetal; cyclic dithioketals (e.g., 1,3-dithiane or 1,3-dithiolane); orthoesters (e.g., those described herein) and triarylmethyl groups (e.g., trityl; monomethoxytrityl (MMTr); 4,4′-dimethoxytrityl (DMTr); 4,4′,4″-trimethoxytrityl (TMTr); and those described herein). Amino-protecting groups are known to those skilled in the art. In general, the species of protecting group is not critical, provided that it is stable to the conditions of any subsequent reaction(s) on other positions of the compound and can be removed at the appropriate point without adversely affecting the remainder of the molecule. In addition, a protecting group may be substituted for another after substantive synthetic transformations are complete. Clearly, where a compound differs from a compound disclosed herein only in that one or more protecting groups of the disclosed compound has been substituted with a different protecting group, that compound is within the disclosure.

Ceragenin compounds include but are not limited to compounds having cationic groups (e.g., amine or guanidine groups) covalently attached to a steroid backbone or scaffold at any carbon position, e.g., cholic acid. In various embodiments, a group is covalently attached at anyone, or more, of positions R₃, R₇, and R₁₂ of the sterol backbone. In additional embodiments, a group is absent from any one or more of positions R₃, R₇, and R₁₂ of the sterol backbone.

Anti-microbial CSA compounds described herein may also include a tether or “tail moiety” attached to the sterol backbone. The tail moiety may have variable chain length or size and may be one of charged, uncharged, polar, non-polar, hydrophobic, amphipathic, and the like. In various embodiments, a tail moiety may be attached at R₁₇ of Formula I. A tail moiety may include a heteroatom (O or N) covalently coupled to the sterol backbone.

Other ring systems can also be used, e.g., 5-member fused rings. Compounds with backbones having a combination of 5-membered and 6-membered rings are also contemplated. Cationic functional groups (e.g., amine or guanidine groups) can be separated from the backbone by at least one, two, three, four or more atoms.

As used in this specification and the appended claims, the singular forms “a”, “an”, and “the” include plural referents unless the context clearly dictates otherwise.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for controlling growth of microbes on a non-meat food product, the method comprising:
applying an anti-microbial wash composition to a surface of a non-meat food product that may be exposed to one or more microbes, wherein the anti-microbial wash composition includes:
a fluid carrier; and
a ceragenin compound dispersed within the carrier, the ceragenin compound having a sterol backbone and a number of cationic groups attached thereto; and
killing one or more types of microbes on the surface of the non-meat food product.

2. The method of claim 1, wherein the wash has a concentration of ceragenin compound in a range from 10 ppm to 1000 ppm.

3. The method of claim 1, wherein the wash has a concentration of ceragenin compound in a range from 25 ppm to 500 ppm.

4. The method of claim 1, wherein the cationic groups are attached to the sterol backbone via hydrolysable linkages.

5. The method of claim 2, wherein the ceragenin compound is selected from the group consisting of CSA-32, CSA-33, CSA-34, CSA-35, CSA-41, CSA-42, CSA-43, CSA-45, CSA-47, CSA-49, CSA-50, CSA-51, CSA-52, CSA-56, CSA-61, CSA-141, CSA-142, and combinations thereof.

6. The method of claim 2, wherein the ceragenin compound is CSA-44.

7. The method of claim 2, wherein the ceragenin compound has a half-life of less than about 40 days within the anti-microbial wash composition so as to minimize any residual presence of the ceragenin compound on the surface of the non-meat food product.

8. The method of claim 1, wherein the antimicrobial wash composition is applied to the surface of the non-meat food product and shipped with the wash applied and after shipment the at least a portion of the antimicrobial wash is rinsed off the surface of the non-meat food product.

9. The method of claim 1, wherein the non-meat food product is selected from the group consisting of fruits, vegetables, grains, and eggs.

10. The method of claim 1, wherein the anti-microbial wash composition is sprayed onto the non-meat food product.

11. The method of claim 1, wherein the non-meat food product is dipped into the anti-microbial wash composition for a period of time from about 10 seconds to about 60 seconds so as to kill one or more types of microbes on the surface of the non-meat food product.

12. The method of claim 1, wherein the fluid carrier comprises water.

13. The method of claim 1, wherein the ceragenin compound is adapted to and present in a concentration sufficient to kill both planktonic and biofilm forms of illness causing bacteria without causing harm to beneficial bacteria residing within a digestive tract of an end user.

14. A method as in claim 1, wherein the non-meat food product is a fruit, a vegetable, or a grain.

15. A non-meat meat food product treated using the method of claim 1 so as to produce a non-meat food product having an increased resistance to microbial colonization.

16. An anti-microbial wash composition for controlling growth of microbes on a non-meat food product, the wash composition comprising:
a fluid carrier having a composition suitable for application to a non-meat food product; and
a ceragenin compound dispersed within the carrier, the ceragenin compound having a sterol backbone and a number of cationic groups attached thereto, wherein the ceragenin compound is included in the fluid carrier at a concentration in a range from 10 ppm to 500 ppm.

17. The anti-microbial wash composition of claim 16, wherein the concentration of ceragenin compound is included in the fluid carrier at a concentration in a range from 25 ppm to 250 ppm

18. The anti-microbial wash composition of claim 16, wherein the fluid carrier comprises water.

19. The anti-microbial wash composition of claim 16, wherein the cationic groups are attached to the sterol backbone via hydrolysable linkages.

20. The anti-microbial wash composition of claim 16, wherein the carrier comprises an acid so that the carrier has a pH of 6 or less.
